(19) United States
(12) Patent Application Publication
(10) Pub. No.: US 2023/0308150 A1
(43) Pub. Date: Sep. 28, 2023

(54) METHOD FOR GENERATING BEAM OF ANTENNA IN WIRELESS COMMUNICATION SYSTEM SUPPORTING THZ BAND, AND APPARATUS THEREFOR

(71) Applicant: LG Electronics Inc., Seoul (KR)

(72) Inventors: Sunam KIM, Seoul (KR); Sungho PARK, Seoul (KR); Minseog KIM, Seoul (KR); Jaehwan KIM, Seoul (KR); Sungryong HONG, Seoul (KR)

(21) Appl. No.: 18/022,065

(22) PCT Filed: Aug. 20, 2020
(86) PCT No.: PCT/KR2020/011125

§ 371 Date: Feb. 17, 2023

(51) Int. Cl. H04B 7/06; H04B 7/024; H01Q 3/36

(52) U.S. Cl. CPC H04B 7/0617; H04B 7/024; H01Q 3/36

(57) ABSTRACT

The present specification provides a method for generating a beam of an antenna in a wireless communication system supporting a THz band. More particularly, the method comprises the steps of: generating the direction of a first beam by applying a specific configuration set to antenna elements in an antenna group on the basis of pre-configured information, wherein the pre-configured information includes one or more configuration sets consisting of configuration values respectively applied to the antenna elements in the antenna group in order to control the direction of the first beam; and generating the direction of a second beam by controlling the phase between antenna groups.

### TECHNICAL FIELD

The present disclosure is for generating a beam of an antenna, and more specifically, relates to a method for generating a beam of an antenna in a wireless communication system supporting a THz band, and apparatus therefor.

### BACKGROUND ART

A wireless communication system is widely deployed to provide various types of communication services such as voice and data. In general, a wireless communication system is a multiple access system capable of supporting communication with multiple users by sharing available system resources (bandwidth, transmission power, etc.). Examples of the multiple access system include a Code Division Multiple Access (CDMA) system, a Frequency Division Multiple Access (FDMA) system, a Time Division Multiple Access (TDMA) system, a Space Division Multiple Access (SDMA) system, and an Orthogonal Frequency Division Multiple Access (OFDMA) system, SC-FDMA (Single Carrier Frequency Division Multiple Access) system, IDMA (Interleave Division Multiple Access) system, and the like.

### DISCLOSURE

### Technical Problem

An object of the present disclosure is to propose a method for generating a beam applicable in a THz band and a structure for controlling a direction of a beam.

Technical problems to be solved by the present disclosure are not limited by the above-mentioned technical problems, and other technical problems which are not mentioned above can be clearly understood by those skilled in the art to which the present disclosure pertains from the following description.

### Technical Solution

The present disclosure provides a method for generating a beam of an antenna in a wireless communication system supporting a THz band.

More specifically, the method performed by a user equipment (UE) comprises generating a direction of a first beam by applying a specific configuration set to antenna elements in an antenna group based on pre-configured information, wherein the pre-configured information includes one or more configuration sets composed of configuration values applied to each of the antenna elements in the antenna group to control the direction of the first beam; and generating a direction of a second beam by controlling a phase between antenna groups.

In addition, in the present disclosure, the first beam is a coarse beam, and the second beam is a fine beam.

In addition, in the present disclosure, the specific configuration set is applied to each of the antenna groups.

In addition, in the present disclosure, the antenna elements in the antenna group, i) configuration of lengths of transmission lines connected to an antenna differently, ii) impedance matching circuits having different reactances or adjustment of a reactance in an impedance matching circuit. iii) changing a feeding position of an antenna element, are controlled based on at least one of i) to iii) above.

In addition, in the present disclosure, the configuration sets are used to determine a phase and a direction for each of the antenna elements in the antenna group.

In addition, in the present disclosure, the configuration sets are determined based on the direction of the first beam.

In addition, in the present disclosure, the phase between the antenna groups is controlled so that signals between each antenna group are co-phased.

In addition, in the present disclosure, the method further comprises receiving control information related to at least one of a mode of the UE and a motion of the UE from a base station; comparing a value related to the motion of the UE with a threshold based on the control information; determining the mode of the UE based on the control information; and determining whether to turn on multi-beams or turn on a maximum beam gain based on the comparison result and the determined mode of the UE.

In addition, in the present disclosure, the mode of the UE is a coordinated multi-point (CoMP) mode or a spatial multiplexing (SM) mode.

In addition, in the present disclosure, when the value related to the motion of the UE is greater than the threshold and the mode of the UE is the CoMP mode, the multi-beams are turned on.

In addition, the present disclosure comprises, in a user equipment (UE) for generating a beam of an antenna in a wireless communication system supporting a THz band, a transmitter transmitting a radio signal; a receiver receiving the radio signal:
at least one processor; and at least one computer memory operably connectable to the at least one processor and storing instructions that perform operations when executed by the at least one processor, wherein the operations includes: generating a direction of a first beam by applying a specific configuration set to antenna elements in an antenna group based on pre-configured information, wherein the pre-configured information includes one or more configuration sets composed of configuration values applied to each of the antenna elements in the antenna group to control the direction of the first beam; and generating a direction of a second beam by controlling a phase between antenna groups.

### Advantageous Effects

The present disclosure has an effect of securing a wide antenna use area and enabling detailed beam adjustment within the corresponding use area.

In addition, the present disclosure has an effect of reducing power consumption and size by reducing the burden of hardware with low complexity.

Effects which may be obtained by the present disclosure are not limited to the aforementioned effects, and other technical effects not described above may be evidently understood by a person having ordinary skill in the art to which the present disclosure pertains from the following description.

### DESCRIPTION OF DRAWINGS

The accompany drawings, which are included to provide a further understanding of the present disclosure and are incorporated on and constitute a part of this specification illustrate embodiments of the present disclosure and together with the description serve to explain the principles of the present disclosure.

FIG. 1 illustrates physical channels and general signal transmission used in a 3GPP system.

FIG. 2 is a view showing an example of a communication structure providable in a 6G system applicable to the present disclosure.

FIG. 3 is a diagram illustrating a structure of a perceptron.

FIG. 4 is a diagram showing an example of a multilayer perceptron structure.

FIG. 5 is a diagram showing an example of a deep neural network.

FIG. 6 is a diagram showing an example of a convolutional neural network.

FIG. 7 is a diagram illustrating an example of a filter operation in a convolutional neural network.

FIG. 8 shows an example of a neural network structure in which a circular loop exists.

FIG. 9 shows an example of an operating structure of a recurrent neural network.

FIG. 10 is a diagram showing an example of an electromagnetic spectrum.

FIG. 11 is a view showing a THz communication method applicable to the present disclosure.

FIG. 12 is a view showing a THz wireless communication transceiver applicable to the present disclosure.

FIG. 13 is a diagram illustrating an example of a method for generating a THz signal based on an optical element.

FIG. 14 is a diagram showing an example of an optical element-based THz wireless communication transceiver.

FIG. 15 is a diagram illustrating a transmitter structure based on a photonic source.

FIG. 16 is a diagram illustrating an optical modulator structure.

FIG. 17 shows an example of a general structure for beam generation.

FIG. 18 shows an example of generating an antenna element radiation pattern by selectively using a plurality of points.

FIG. 19 is a diagram showing an example of a method for controlling an antenna element proposed in the present disclosure.

FIG. 20 shows an example of beam generation by an antenna group proposed in the present disclosure.

FIG. 21 is an example of a structure for supporting Rule 1 and Rule 2.

FIGS. 22 and 23 show examples of beam shapes generated by FIGS. 20 and 21.

FIGS. 24 and 25 show examples of structures for THz beam generation proposed in the present disclosure.

FIG. 26 is a flowchart illustrating an example of a method for generating a beam proposed in the present disclosure.

FIG. 27 is a flowchart illustrating an example of an operation method of a UE for generating a beam of an antenna proposed in the present disclosure.

FIG. 28 illustrates a communication system applied to the present disclosure.

FIG. 29 illustrates wireless devices applicable to the present disclosure.

FIG. 30 illustrates a signal process circuit for a transmission signal.

FIG. 31 illustrates another example of a wireless device applied to the present disclosure.

FIG. 32 illustrates a hand-held device applied to the present disclosure.

FIG. 33 illustrates a vehicle or an autonomous driving vehicle applied to the present disclosure.

FIG. 34 illustrates a vehicle applied to the present disclosure.

FIG. 35 illustrates an XR device applied to the present disclosure.

FIG. 36 illustrates a robot applied to the present disclosure.

FIG. 37 illustrates an AI device applied to the present disclosure.

### MODE FOR INVENTION

The following technologies may be used in a variety of wireless communication systems, such as code division multiple access (CDMA), frequency division multiple access (FDMA), time division multiple access (TDMA), orthogonal frequency division multiple access (OFDMA), single carrier frequency division multiple access (SC-FDMA), and non-orthogonal multiple access (NOMA). CDMA may be implemented using a radio technology, such as universal terrestrial radio access (UTRA) or CDMA2000. TDMA may be implemented using a radio technology, such as global system for mobile communications (GSM)/general packet radio service (GPRS)/enhanced data rates for GSM evolution (EDGE). OFDMA may be implemented using a radio technology, such as Institute of electrical and electronics engineers (IEEE) 802.11 (Wi-Fi), IEEE 802.16 (WiMAX), IEEE 802.20, or evolved UTRA (E-UTRA). UTRA is part of a universal mobile telecommunications system (UMTS). 3rd generation partnership project (3GPP) Long term evolution (LTE) is part of an evolved UMTS (E-UMTS) using evolved UMTS terrestrial radio access (E-UTRA), and it adopts OFDMA in downlink and adopts SC-FDMA in uplink. LTE-advanced (LTE-A) is the evolution of 3GPP LTE.

For clarity, the description is based on a 3GPP communication system (eg, LTE, NR, etc.), but the technical idea of the present invention is not limited thereto. LTE refers to the technology after 3GPP TS 36.xxx Release 8. In detail, LTE technology after 3GPP TS 36.xxx Release 10 is referred to as LTE-A, and LTE technology after 3GPP TS 36.xxx Release 13 is referred to as LTE-A pro. 3GPP NR refers to the technology after TS 38.xxx Release 15. 3GPP 6G may mean technology after TS Release 17 and/or Release 18. “xxx” means standard document detail number. LTE/NR/6G may be collectively referred to as a 3GPP system. Background art, terms, abbreviations, and the like used in the description of the present invention may refer to matters described in standard documents published before the present invention. For example, you can refer to the following document:

3GPP LTE
36.211: Physical channels and modulation
36.212: Multiplexing and channel coding
36.213: Physical layer procedures
36.300: Overall description
36.331: Radio Resource Control (RRC)

3GPP NR
38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

Physical Channel and Frame Structure

Physical Channels and General Signal Transmission

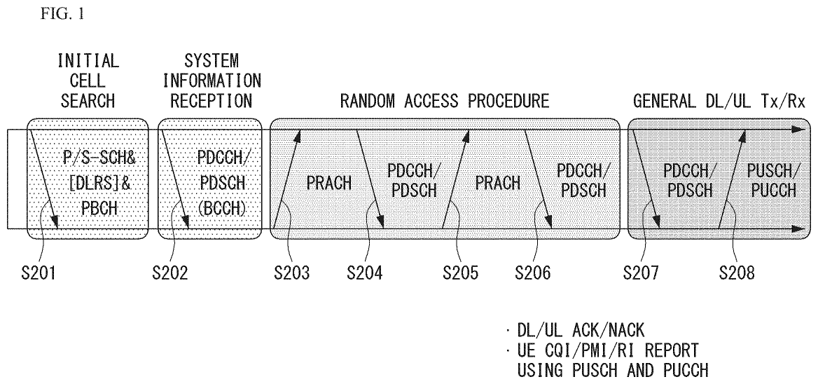

FIG. 1 illustrates physical channels and general signal transmission used in a 3GPP system. In a wireless communication system, a terminal receives information from a base station through a downlink (DL), and the terminal transmits information to the base station through an uplink (UL). The information transmitted and received by the base station and the terminal includes data and various control information, and various physical channels exist according to the type/use of information transmitted and received by them.

When the terminal is powered on or newly enters a cell, the terminal performs an initial cell search operation such as synchronizing with the base station (S11). To this end, the UE receives a Primary Synchronization Signal (PSS) and a Secondary Synchronization Signal (SSS) from the base station to synchronize with the base station and obtain information such as cell ID. Thereafter, the terminal may receive a physical broadcast channel (PBCH) from the base station to obtain intra-cell broadcast information. Meanwhile, the UE may receive a downlink reference signal (DL RS) in the initial cell search step to check a downlink channel state.

After completing the initial cell search, the UE receives a physical downlink control channel (PDCCH) and a physical downlink shared channel (PDSCH) according to the information carried on the PDCCH, thereby receiving a more specific system Information can be obtained (S12).

On the other hand, when accessing the base station for the first time or when there is no radio resource for signal transmission, the terminal may perform a random access procedure (RACH) for the base station (S13 to S16). To this end, the UE transmits a specific sequence as a preamble through a physical random access channel (PRACH) (S13 and S15), and a response message to the preamble through a PDCCH and a corresponding PDSCH (RAR (Random Access Response) message) In the case of contention-based RACH, a contention resolution procedure may be additionally performed (S16).

After performing the above-described procedure, the UE receives PDCCH/PDSCH (S17) and physical uplink shared channel (PUSCH)/physical uplink control channel as a general uplink/downlink signal transmission procedure. (Physical Uplink Control Channel; PUCCH) transmission (S18) can be performed. In particular, the terminal may receive downlink control information (DCI) through the PDCCH. Here, the DCI includes control information such as resource allocation information for the terminal, and different formats may be applied according to the purpose of use.

On the other hand, control information transmitted by the terminal to the base station through uplink or received by the terminal from the base station is a downlink/uplink ACK/NACK signal, a channel quality indicator (CQI), a precoding matrix index (PMI), and (Rank Indicator) may be included. The terminal may transmit control information such as CQI/PMI/RI described above through PUSCH and/or PUCCH.

Structure of Uplink and Downlink Channels

Downlink Channel Structure

The base station transmits a related signal to the terminal through a downlink channel to be described later, and the terminal receives a related signal from the base station through a downlink channel to be described later.

(1) Physical Downlink Shared Channel (PDSCH)

PDSCH carries downlink data (eg, DL-shared channel transport block, DL-SCH TB), and includes Quadrature Phase Shift Keying (QPSK), Quadrature Amplitude Modulation (QAM), 64 QAM, 256 QAM, etc. The modulation method is applied. A codeword is generated by encoding TB. The PDSCH can carry multiple codewords. Scrambling and modulation mapping are performed for each codeword, and modulation symbols generated from each codeword are mapped to one or more layers (Layer mapping). Each layer is mapped to a resource together with a demodulation reference signal (DMRS) to generate an OFDM symbol signal, and is transmitted through a corresponding antenna port.

(2) Physical Downlink Control Channel (PDCCH)

The PDCCH carries downlink control information (DCI) and a QPSK modulation method is applied. One PDCCH is composed of 1, 2, 4, 8, 16 Control Channel Elements (CCEs) according to the Aggregation Level (AL). One CCE consists of 6 REGs (Resource Element Group). One REG is defined by one OFDM symbol and one (P)RB.

The UE acquires DCI transmitted through the PDCCH by performing decoding (aka, blind decoding) on the set of PDCCH candidates. The set of PDCCH candidates decoded by the UE is defined as a PDCCH search space set. The search space set may be a common search space or a UE-specific search space. The UE may acquire DCI by monitoring PDCCH candidates in one or more search space sets set by MIB or higher layer signaling.

Unlink Channel Structure

The terminal transmits a related signal to the base station through an uplink channel to be described later, and the base station receives a related signal from the terminal through an uplink channel to be described later.

(1) Physical Uplink Shared Channel (PUSCH)

PUSCH carries uplink data (eg, UL-shared channel transport block, UL-SCH TB) and/or uplink control information (UCI), and CP-OFDM (Cyclic Prefix—Orthogonal Frequency Division Multiplexing) waveform (waveform), DFT-s-OFDM (Discrete Fourier Transform-spread-Orthogonal Frequency Division Multiplexing) is transmitted based on the waveform. When the PUSCH is transmitted based on the DFT-s-OFDM waveform, the UE transmits the PUSCH by applying transform precoding. For example, when transform precoding is not possible (eg, transform precoding is disabled), the UE transmits a PUSCH based on the CP-OFDM waveform, and when transform precoding is possible (eg, transform precoding is enabled), the UE is CP-OFDM. PUSCH may be transmitted based on a waveform or a DFT-s-OFDM waveform. PUSCH transmission is dynamically scheduled by the UL grant in the DCI or is semi-static based on higher layer (e.g., RRC) signaling (and/or Layer 1 (L1) signaling (e.g., PDCCH)). Can be scheduled (configured grant). PUSCH transmission may be performed based on a codebook or a non-codebook.

(2) Physical Uplink Control Channel (PUCCH)

The PUCCH carries uplink control information, HARQ-ACK, and/or scheduling request (SR), and may be divided into a plurality of PUCCHs according to the PUCCH transmission length.

6G System General

A 6G (wireless communication) system has purposes such as (i) very high data rate per device. (ii) a very large number of connected devices, (iii) global connectivity. (iv) very low latency. (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table I below. That is, Table I shows the requirements of the 6G system.

TABLE 1

| | |
|---|---|
| Per device peak data rate | 1 Tbps |
| E2E latency | 1 ms |
| Maximum spectral efficiency | 100 bps/Hz |
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

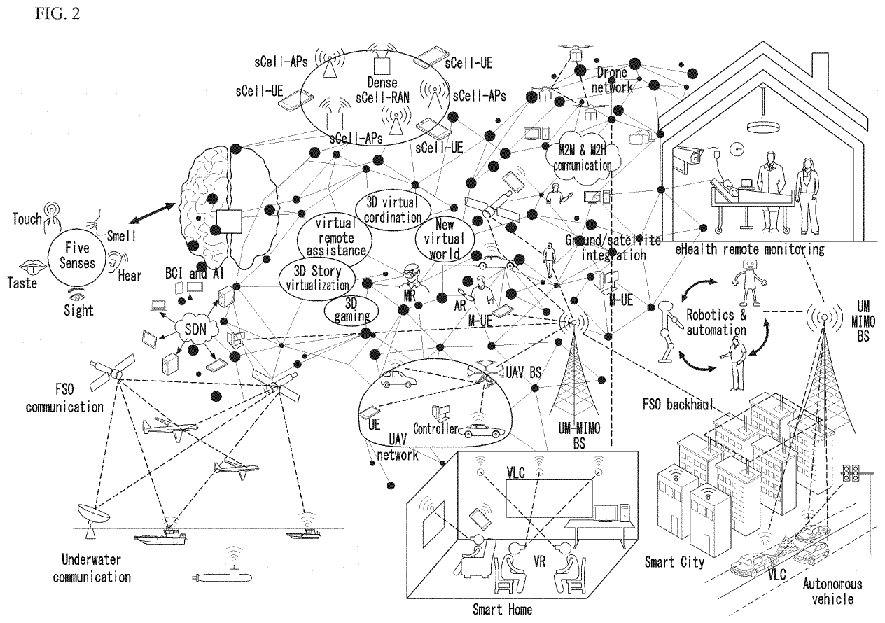

FIG. 2 is a view showing an example of a communication structure providable in a 6G system applicable to the present disclosure.

Referring to FIG. 2, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduce costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability. In addition, billions of devices can be shared in a shared physical infrastructure.

Core Implementation Technology of 6G System

Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to create a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

An artificial neural network is an example of connecting several perceptrons.

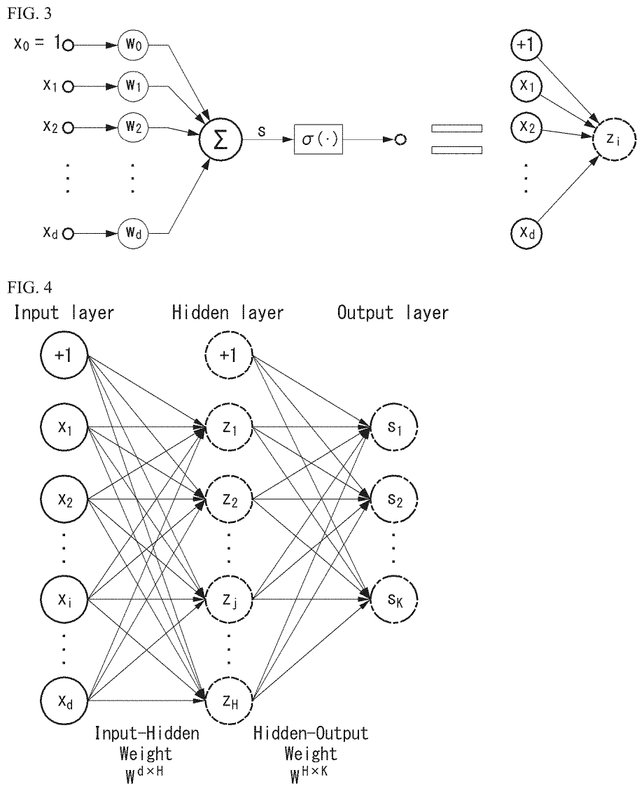

FIG. 3 is a diagram illustrating a structure of a perceptron.

Referring to FIG. 3, when an input vector x=(x1, x2, . . . , xd) is input, each component is multiplied by a weight (W1, W2, . . . , Wd), and all the results are summed. After that, the entire process of applying the activation function σ(⋅) is called a perceptron. The huge artificial neural network structure may extend the simplified perceptron structure shown in FIG. 3 to apply input vectors to different multidimensional perceptrons. For convenience of explanation, an input value or an output value is referred to as a node.

Meanwhile, the perceptron structure illustrated in FIG. 3 may be described as being composed of a total of three layers based on an input value and an output value. An artificial neural network in which H (d+1) dimensional perceptrons exist between the 1st layer and the 2nd layer, and K (H+1) dimensional perceptrons exist between the 2nd layer and the 3rd layer, as shown in FIG. 4.

FIG. 4 is a diagram showing an example of a multilayer perceptron structure.

The layer where the input vector is located is called an input layer, the layer where the final output value is located is called the output layer, and all layers located between the input layer and the output layer are called a hidden layer. In the example of FIG. 4, three layers are disclosed, but since the number of layers of the artificial neural network is counted excluding the input layer, it can be viewed as a total of two layers. The artificial neural network is constructed by connecting the perceptrons of the basic blocks in two dimensions.

The above-described input layer, hidden layer, and output layer can be jointly applied in various artificial neural network structures such as CNN and RNN to be described later as well as multilayer perceptrons. The greater the number of hidden layers, the deeper the artificial neural network is, and the machine learning paradigm that uses the deep enough artificial neural network as a learning model is called Deep Learning. In addition, the artificial neural network used for deep learning is called a deep neural network (DNN).

FIG. 5 is a diagram showing an example of a deep neural network.

The deep neural network shown in FIG. 5 is a multilayer perceptron composed of eight hidden layers+output layers. The multilayer perceptron structure is expressed as a fully-connected neural network. In a fully connected neural network, a connection relationship does not exist between nodes located on the same layer, and a connection relationship exists only between nodes located on adjacent layers. DNN has a fully connected neural network structure and is composed of a combination of multiple hidden layers and activation functions, so it can be usefully applied to understand the correlation characteristics between input and output. Here, the correlation characteristic may mean a joint probability of input/output.

On the other hand, depending on how the plurality of perceptrons are connected to each other, various artificial neural network structures different from the aforementioned DNN can be formed.

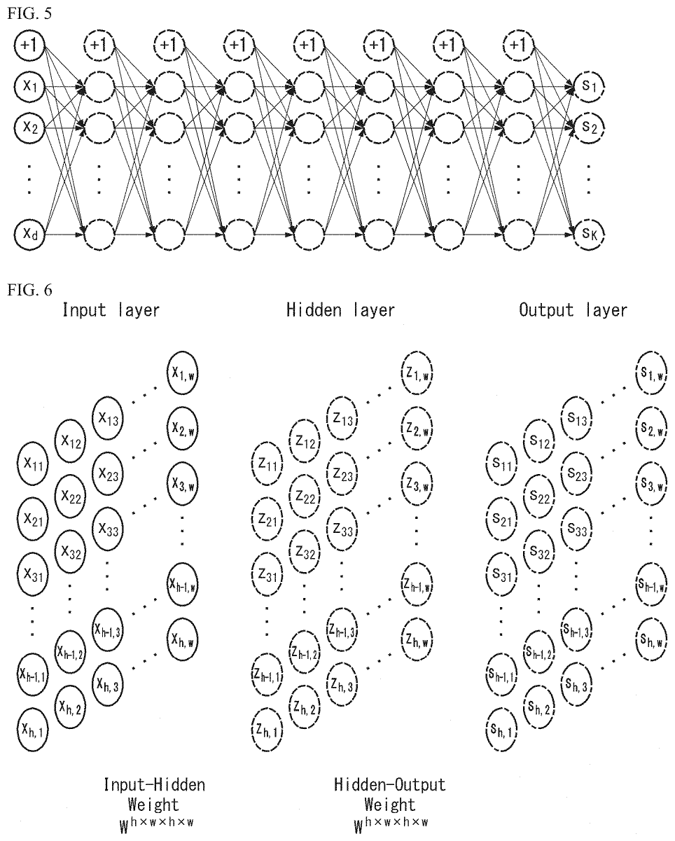

In a DNN, nodes located inside one layer are arranged in a one-dimensional vertical direction. However, in FIG. 6, it may be assumed that w nodes are arranged in two dimensions, and h nodes are arranged in a two-dimensional manner (convolutional neural network structure of FIG. 6). In this case, since a weight is added per connection in the connection process from one input node to the hidden layer, a total of h×w weights must be considered. Since there are h×w nodes in the input layer, a total of h2w2 weights are required between two adjacent layers.

FIG. 6 is a diagram showing an example of a convolutional neural network.

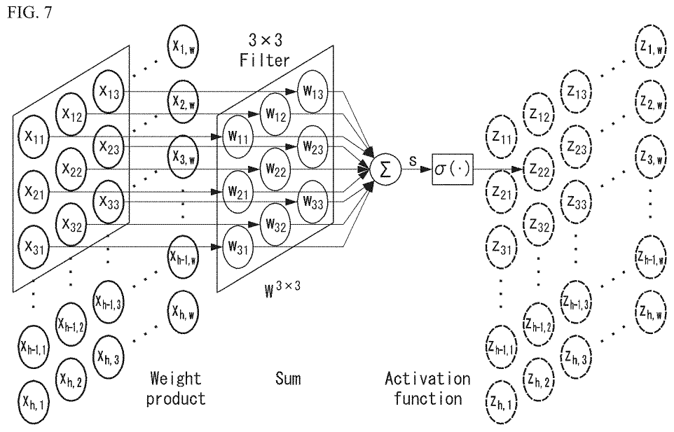

The convolutional neural network of FIG. 6 has a problem in that the number of weights increases exponentially according to the number of connections, so instead of considering the connection of all modes between adjacent layers, it is assumed that a filter having a small size exists. Thus, as shown in FIG. 7, weighted sum and activation function calculations are performed on a portion where the filters overlap.

One filter has a weight corresponding to the number as much as the size, and learning of the weight may be performed so that a certain feature on an image can be extracted and output as a factor. In FIG. 7, a filter having a size of 3×3 is applied to the upper leftmost 3×3 area of the input layer, and an output value obtained by performing a weighted sum and activation function operation for a corresponding node is stored in z22.

While scanning the input layer, the filter performs weighted summation and activation function calculation while moving horizontally and vertically by a predetermined interval, and places the output value at the position of the current filter. This method of operation is similar to the convolution operation on images in the field of computer vision, so a deep neural network with this structure is called a convolutional neural network (CNN), and a hidden layer generated as a result of the convolution operation. Is referred to as a convolutional layer. In addition, a neural network in which a plurality of convolutional layers exists is referred to as a deep convolutional neural network (DCNN).

FIG. 7 is a diagram illustrating an example of a filter operation in a convolutional neural network.

In the convolutional layer, the number of weights may be reduced by calculating a weighted sum by including only nodes located in a region covered by the filter in the node where the current filter is located. Due to this, one filter can be used to focus on features for the local area. Accordingly, the CNN can be effectively applied to image data processing in which the physical distance in the 2D area is an important criterion. Meanwhile, in the CNN, a plurality of filters may be applied immediately before the convolution layer, and a plurality of output results may be generated through a convolution operation of each filter.

Meanwhile, there may be data whose sequence characteristics are important according to data properties. Considering the length variability of the sequence data and the relationship between the sequence data, one element in the data sequence is input at each timestep, and the output vector (hidden vector) of the hidden layer output at a specific time point is input together with the next element in the sequence. The structure applied to the artificial neural network is called a recurrent neural network structure.

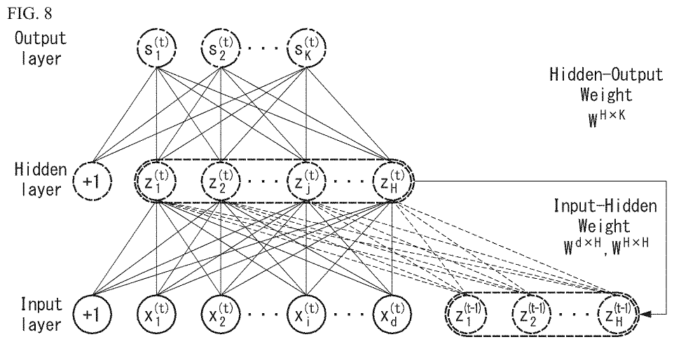

FIG. 8 shows an example of a neural network structure in which a circular loop exists.

Referring to FIG. 8, a recurrent neural network (RNN) is a fully connected neural network with elements (x1(t), x2(t), . . . , xd(t)) of any line of sight t on a data sequence. In the process of inputting, the point t−1 immediately preceding is the weighted sum and activation function by inputting the hidden vectors (z1(t−1), z2(t−1), . . . , zH(t−1)) together. It is a structure to be applied. The reason for transferring the hidden vector to the next view in this way is that information in the input vector at the previous views is regarded as accumulated in the hidden vector of the current view.

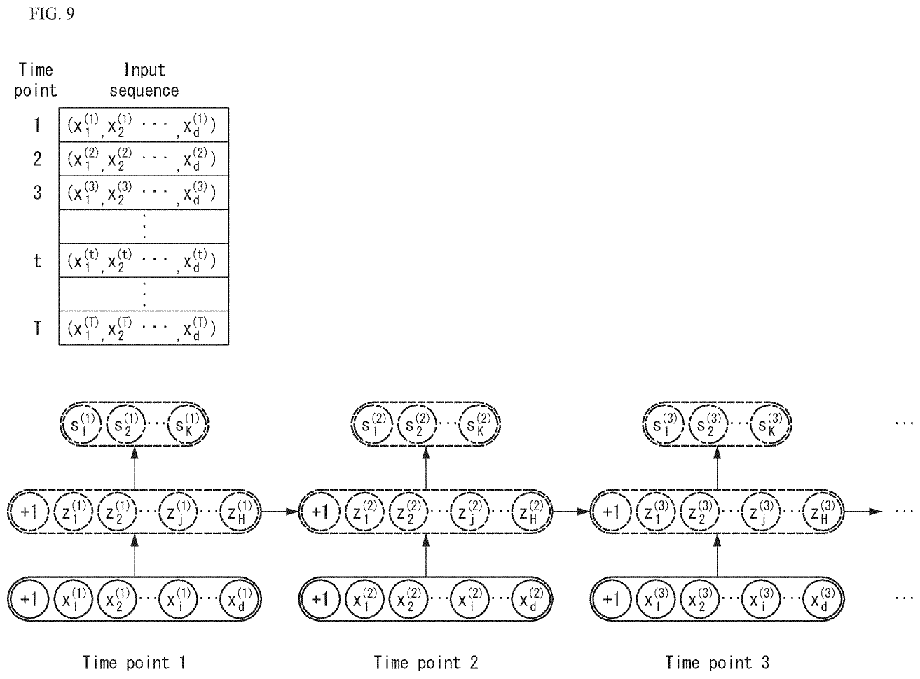

FIG. 9 shows an example of an operating structure of a recurrent neural network.

Referring to FIG. 9, the recurrent neural network operates in a predetermined order of time with respect to an input data sequence.

Hidden vectors (z1(1), z2(1), . . . , zH(1)) is input with the input vector (x1(2), x2(2), . . . , xd(2)) of the time point 2, and the vector (z1(2), z2(2), . . . , zH(2)) is determined. This process is repeatedly performed up to the time point 2, time point 3, . . . , time point T.

Meanwhile, when a plurality of hidden layers are disposed in a recurrent neural network, this is referred to as a deep recurrent neural network (DRNN). The recurrent neural network is designed to be usefully applied to sequence data (for example, natural language processing).

As a neural network core used as a learning method, in addition to DNN, CNN, and RNN, Restricted Boltzmann Machine (RBM), deep belief networks (DBN), and deep Q-networks Network), and can be applied to fields such as computer vision, speech recognition, natural language processing, and voice/signal processing.

In recent years, attempts to integrate AI with a wireless communication system have appeared, but this has been concentrated in the field of wireless resource management and allocation in the application layer, network layer, in particular, deep learning. However, such research is gradually developing into the MAC layer and the physical layer, and in particular, attempts to combine deep learning with wireless transmission in the physical layer have appeared. The AI-based physical layer transmission refers to applying a signal processing and communication mechanism based on an AI driver rather than a traditional communication framework in the fundamental signal processing and communication mechanism. For example, deep learning-based channel coding and decoding, deep learning-based signal estimation and detection, deep learning-based MIMO mechanism, AI-based resource scheduling, and It may include allocation and the like.

Terahertz (THz) Communication

THz communication is applicable to the 6G system. For example, a data rate may increase by increasing bandwidth. This may be performed by using sub-TH communication with wide bandwidth and applying advanced massive MIMO technology. THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

Optical Wireless Technology

Optical wireless communication (OWC) technology is planned for 6G communication in addition to RF based communication for all possible device-to-access networks. This network is connected to a network-to-backhaul/fronthaul network connection. OWC technology has already been used since 4G communication systems but will be more widely used to satisfy the requirements of the 6G communication system. OWC technologies such as light fidelity/visible light communication, optical camera communication and free space optical (FSO) communication based on wide band are well-known technologies. Communication based on optical wireless technology may provide a very high data rate, low latency and safe communication. Light detection and ranging (LiDAR) may also be used for ultra high resolution 3D mapping in 6G communication based on wide band.

FSO Backhaul Network

The characteristics of the transmitter and receiver of the FSO system are similar to those of an optical fiber network. Accordingly, data transmission of the FSO system similar to that of the optical fiber system. Accordingly, FSO may be a good technology for providing backhaul connection in the 6G system along with the optical fiber network. When FSO is used, very long-distance communication is possible even at a distance of 10,000 km or more. FSO supports mass backhaul connections for remote and non-remote areas such as sea, space, underwater and isolated islands. FSO also supports cellular base station connections.

Massive MIMO Technology

One of core technologies for improving spectrum efficiency is MIMO technology. When MIMO technology is improved, spectrum efficiency is also improved. Accordingly, massive MIMO technology will be important in the 6G system. Since MIMO technology uses multiple paths, multiplexing technology and beam generation and management technology suitable for the THz band should be significantly considered such that data signals are transmitted through one or more paths.

Blockchain

A blockchain will be important technology for managing large amounts of data in future communication systems. The blockchain is a form of distributed ledger technology, and distributed ledger is a database distributed across numerous nodes or computing devices. Each node duplicates and stores the same copy of the ledger. The blockchain is managed through a peer-to-peer (P2P) network. This may exist without being managed by a centralized institution or server. Blockchain data is collected together and organized into blocks. The blocks are connected to each other and protected using encryption. The blockchain completely complements large-scale IoT through improved interoperability, security, privacy, stability and scalability. Accordingly, the blockchain technology provides several functions such as interoperability between devices, high-capacity data traceability, autonomous interaction of different IoT systems, and large-scale connection stability of 6G communication systems.

3D Networking

The 6G system integrates terrestrial and public networks to support vertical expansion of user communication. A 3D BS will be provided through low-orbit satellites and UAVs. Adding new dimensions in terms of altitude and related degrees of freedom makes 3D connections significantly different from existing 2D networks.

Quantum Communication

In the context of the 6G network, unsupervised reinforcement learning of the network is promising. The supervised learning method cannot label the vast amount of data generated in 6G. Labeling is not required for unsupervised learning. Thus, this technique can be used to autonomously build a representation of a complex network. Combining reinforcement learning with unsupervised learning may enable the network to operate in a truly autonomous way.

Unmanned Aerial Vehicle

An unmanned aerial vehicle (UAV) or drone will be an important factor in 6G wireless communication. In most cases, a high-speed data wireless connection is provided using UAV technology. A base station entity is installed in the UAV to provide cellular connectivity. UAVs have certain features, which are not found in fixed base station infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC and mMTC. The UAV can also serve a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

Cell-Free Communication

The tight integration of multiple frequencies and heterogeneous communication technologies is very important in the 6G system. As a result, a user can seamlessly move from network to network without having to make any manual configuration in the device. The best network is automatically selected from the available communication technologies. This will break the limitations of the cell concept in wireless communication. Currently, user movement from one cell to another cell causes too many handovers in a high-density network, and causes handover failure, handover delay, data loss and ping-pong effects. 6G cell-free communication will overcome all of them and provide better QoS. Cell-free communication will be achieved through multi-connectivity and multi-tier hybrid technologies and different heterogeneous radios in the device.

Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without batteries will be supported in 6G communication.

Integration of Sensing and Communication

An autonomous wireless network is a function for continuously detecting a dynamically changing environment state and exchanging information between different nodes. In 6G, sensing will be tightly integrated with communication to support autonomous systems.

Integration of Access Backhaul Network

In 6G, the density of access networks will be enormous. Each access network is connected by optical fiber and backhaul connection such as FSO network. To cope with a very large number of access networks, there will be a tight integration between the access and backhaul networks.

Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram beamforming (HBF) is a new beamforming method that differs significantly from MIMO systems because this uses a software-defined antenna. HBF will be a very effective approach for efficient and flexible transmission and reception of signals in multi-antenna communication devices in 6G.

Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

Large Intelligent Surface (LIS)

In the case of the THz band signal, since the straightness is strong, there may be many shaded areas due to obstacles. By installing the LIS near these shaded areas, LIS technology that expands a communication area, enhances communication stability, and enables additional optional services becomes important. The LIS is an artificial surface made of electromagnetic materials, and can change propagation of incoming and outgoing radio waves. The LIS can be viewed as an extension of massive MIMO, but differs from the massive MIMO in array structures and operating mechanisms. In addition, the LIS has an advantage such as low power consumption, because this operates as a reconfigurable reflector with passive elements, that is, signals are only passively reflected without using active RF chains. In addition, since each of the passive reflectors of the LIS must independently adjust the phase shift of an incident signal, this may be advantageous for wireless communication channels. By properly adjusting the phase shift through an LIS controller, the reflected signal can be collected at a target receiver to boost the received signal power.

Terahertz (THz) Wireless Communications in General

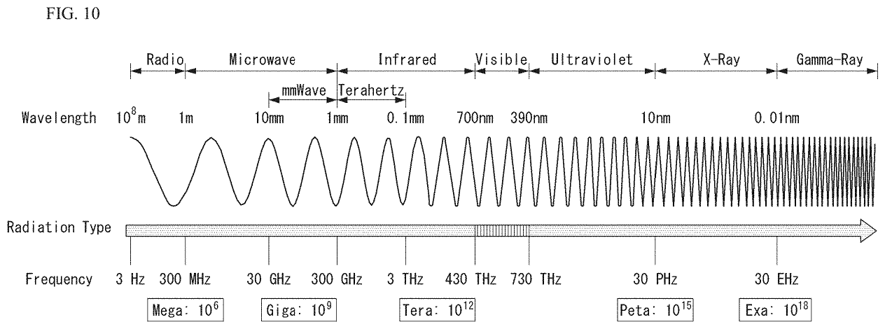

FIG. 10 is a diagram showing an example of an electromagnetic spectrum.

THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence. In addition, the photon energy of the THz wave is only a few meV and thus is harmless to the human body. A frequency band which will be used for THz wireless communication may be a D-band (110 GHz to 170 GHz) or a H-band (220 GHz to 325 GHz) band with low propagation loss due to molecular absorption in air. Standardization discussion on THz wireless communication is being discussed mainly in IEEE 802.15 THz working group (WG), in addition to 3GPP, and standard documents issued by a task group (TG) of IEEE 802.15 (e.g., TG3d, TG3e) specify and supplement the description of this disclosure. The THz wireless communication may be applied to wireless cognition, sensing, imaging, wireless communication, and THz navigation.

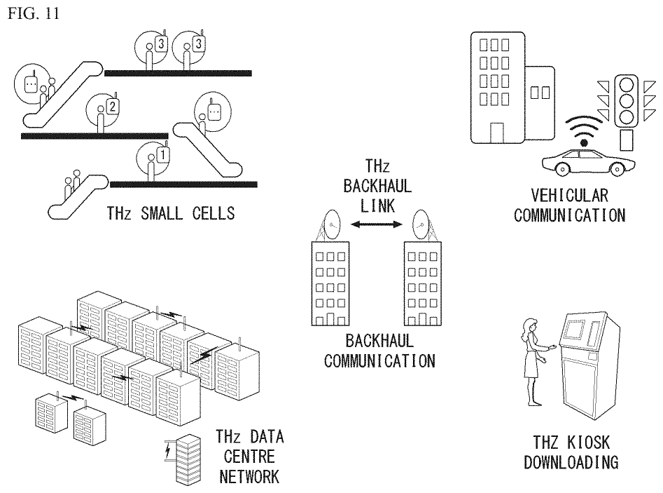

FIG. 11 is a view showing a THz communication method applicable to the present disclosure.

Referring to FIG. 11, a THz wireless communication scenario may be classified into a macro network, a micro network, and a nanoscale network. In the macro network, THz wireless communication may be applied to vehicle-to-vehicle (V2V) connection and backhaul/fronthaul connection. In the micro network, THz wireless communication may be applied to near-field communication such as indoor small cells, fixed point-to-point or multi-point connection such as wireless connection in a data center or kiosk downloading.

Table 2 below shows an example of technology which may be used in the THz wave.

TABLE 2

| | |
|---|---|
| Transceivers Device | Available immature: UTC-PD, RTD and SBD |
| Modulation and | Low order modulation techniques (OOK, |
| coding | QPSK), LDPC, Reed Soloman, Hamming, |
| | Polar, Turbo |
| Antenna | Omni and Directional, phased array with low |
| | number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

THz wireless communication can be classified based on a method for generating and receiving THz. The THz generation method can be classified as an optical device or an electronic device-based technology.

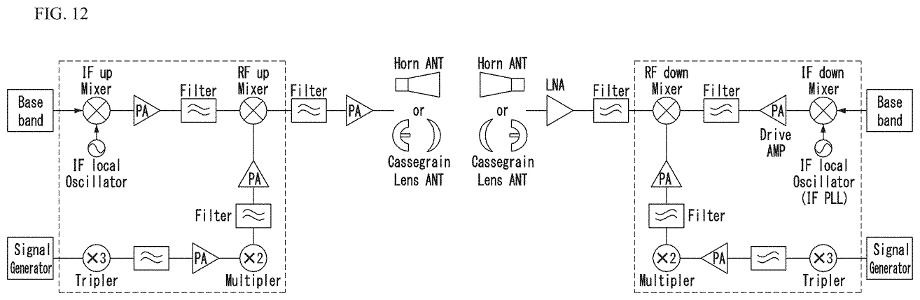

FIG. 12 is a view showing a THz wireless communication transceiver applicable to the present disclosure.

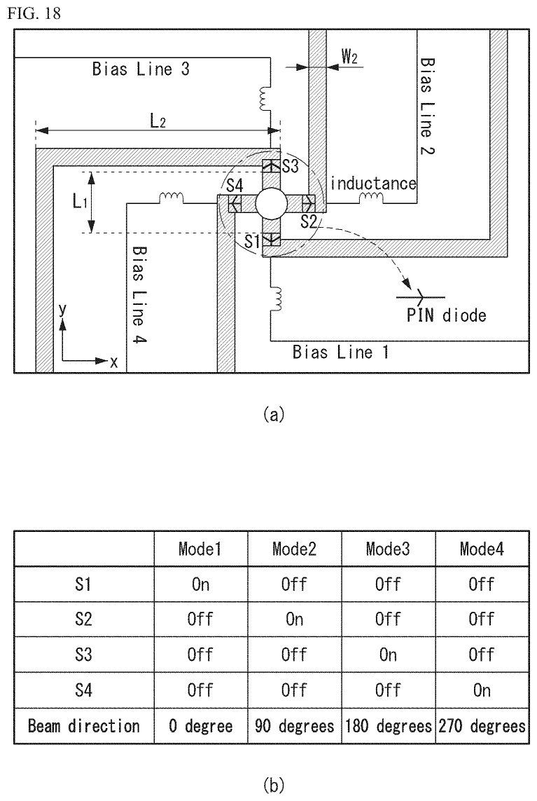

The method of generating THz using an electronic device includes a method using a semiconductor device such as a resonance tunneling diode (RTD), a method using a local to oscillator and a multiplier, a monolithic microwave integrated circuit (MMIC) method using a compound semiconductor high electron mobility transistor (HEMT) based integrated circuit, and a method using a Si-CMOS-based integrated circuit. In the case of FIG. 18, a multiplier (doubler, tripler, multiplier) is applied to increase the frequency, and radiation is performed by an antenna through a subharmonic mixer. Since the THz band forms a high frequency, a is multiplier is essential. Here, the multiplier is a circuit having an output frequency which is N times an input frequency, and matches a desired harmonic frequency, and filters out all other frequencies. In addition, beamforming may be implemented by applying an array antenna or the like to the antenna of FIG. 18. In FIG. 18, IF represents an intermediate frequency, a tripler and a multiplier represents a multiplier, PA represents a power amplifier, and LNA represents a low noise amplifier, and PLL represents a phase-locked loop.

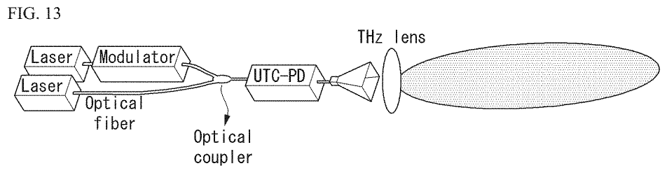

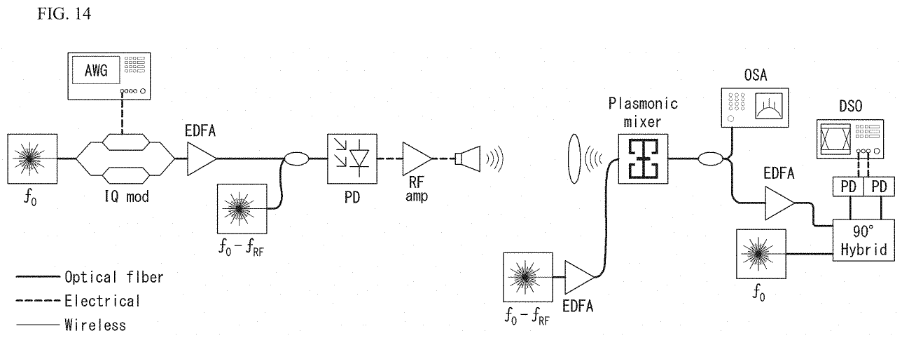

FIG. 13 is a diagram illustrating an example of a method for generating a THz signal based on an optical element and FIG. 14 is a diagram showing an example of an optical element-based THz wireless communication transceiver.

Referring to FIGS. 13 and 14, the optical device-based THz wireless communication technology means a method of generating and modulating a THz signal using an optical device. The optical device-based THz signal generation technology refers to a technology that generates an ultrahigh-speed optical signal using a laser and an optical modulator, and converts it into a THz signal using an ultrahigh-speed photodetector. This technology is easy to increase the frequency compared to the technology using only the electronic device, can generate a high-power signal, and can obtain a flat response characteristic in a wide frequency band. In order to generate the THz signal based on the optical device, as shown in FIG. 13, a laser diode, a broadband optical modulator, and an ultrahigh-speed photodetector are required. In the case of FIG. 13, the light signals of two lasers having different wavelengths are combined to generate a THz signal corresponding to a wavelength difference between the lasers. In FIG. 13, an optical coupler refers to a semiconductor device that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 14, an erbium-doped fiber amplifier (EDFA) represents an optical fiber amplifier to which erbium is added, a photo detector (PD) represents a semiconductor device capable of converting an optical signal into an electrical signal, and OSA represents an optical sub assembly in which various optical communication functions (e.g., photoelectric conversion, electrophotic conversion, etc.) are modularized as one component, and DSO represents a digital storage oscilloscope.

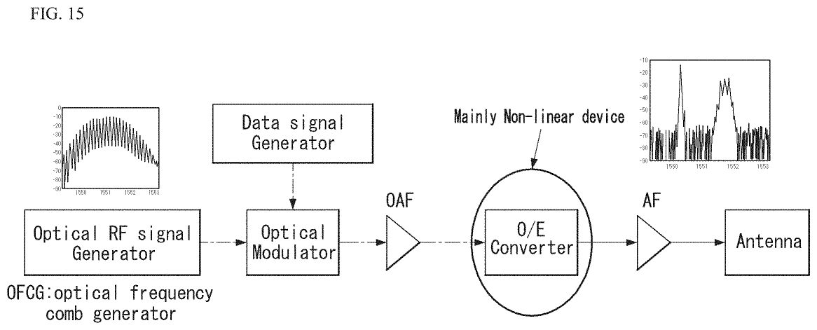

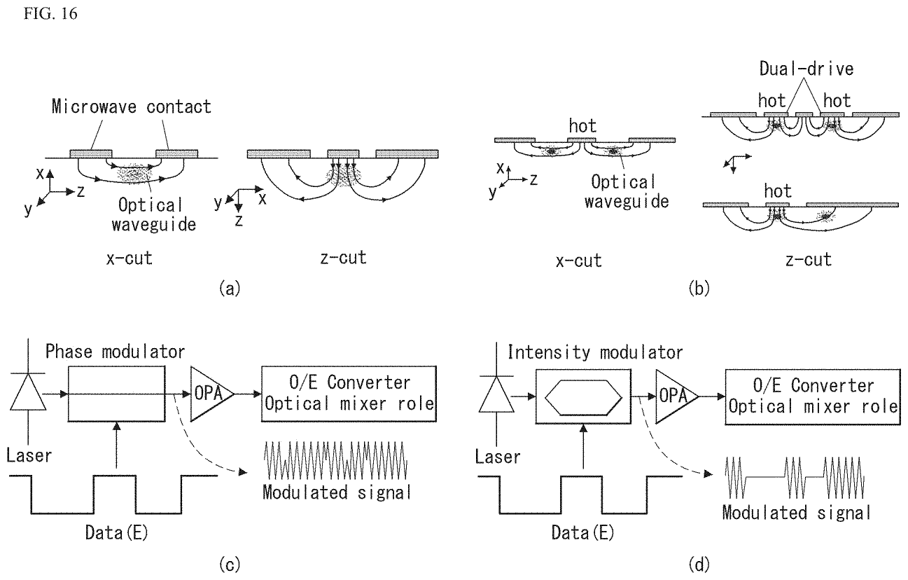

The structure of a photoelectric converter (or photoelectric converter) will be described with reference to FIGS. 15 and 16. FIG. 15 illustrates a transmitter structure based on a photonic source. FIG. 16 illustrates an optical modulator structure.

generally, the optical source of the laser may change the phase of a signal by passing through the optical wave guide. At this time, data is carried by changing electrical characteristics through microwave contact or the like. Thus, the optical modulator output is formed in the form of a modulated waveform. A photoelectric modulator (O/E converter) may generate THz pulses according to optical rectification operation by a nonlinear crystal, photoelectric conversion (O/E conversion) by a photoconductive antenna, and emission from a bunch of relativistic electrons. The terahertz pulse (THz pulse) generated in the above manner may have a length of a unit from femto second to pico second. The photoelectric converter (O/E converter) performs down conversion using non-linearity of the device.

Given THz spectrum usage, multiple contiguous GHz bands are likely to be used as fixed or mobile service usage for the terahertz system. According to the outdoor scenario criteria, available bandwidth may be classified based on oxygen attenuation 10\hat{ }2 dB/km in the spectrum of up to 1 THz. Accordingly, a framework in which the available bandwidth is composed of several band chunks may be considered. As an example of the framework, if the length of the terahertz pulse (THz pulse) for one carrier (carrier) is set to 50 ps, the bandwidth (BW) is about 20 GHz.

Effective down conversion from the infrared band to the terahertz band depends on how to utilize the nonlinearity of the O/E converter. That is, for down-conversion into a desired terahertz band (THz band), design of the photoelectric converter (O/E converter) having the most ideal non-linearity to move to the corresponding terahertz band (THz band) is required. If a photoelectric converter (O/E converter) which is not suitable for a target frequency band is used, there is a high possibility that an error occurs with respect to the amplitude and phase of the corresponding pulse.

In a single carrier system, a terahertz transmission/reception system may be implemented using one photoelectric converter. In a multi-carrier system, as many photoelectric converters as the number of carriers may be required, which may vary depending on the channel environment. Particularly, in the case of a multi-carrier system using multiple broadbands according to the plan related to the above-described spectrum usage, the phenomenon will be prominent. In this regard, a frame structure for the multi-carrier system can be considered. The down-frequency-converted signal based on the photoelectric converter may be transmitted in a specific resource region (e.g., a specific frame). The frequency domain of the specific resource region may include a plurality of chunks. Each chunk may be composed of at least one component carrier (CC).

Beamforming Technology

Beamforming in mobile communication may be performed through arrangement of antenna elements (hereafter, ant_el) and adjustment of their respective phases and sizes.

At this time, this (antenna element) phase/size may be classified into a method performed in the digital domain and a method performed in the analog domain. This is referred to as digital beamforming and analog beamforming, respectively. In addition, a mixing method of these may be considered, which is called hybrid beamforming. The arrangement of Ant_el may consider 1D method (linear, circular, etc.) and 2D planer array method, and the beam controllable range of these is determined based on the configuration method. That is, in the case of the 1D linear method, the beam can be controlled in the linear arrangement direction, and in the 2D planer array method, the beam can be adjusted in all directions up/down and left/right. At this time, in general, in order to optimally control the gain and direction of the beam, the interval of Ant_el is configured as ½λ or less of the used frequency wavelength (λ). At this time, the generated beam width and gain have a close relationship with the number of used antennas and the area forming the entire antenna.

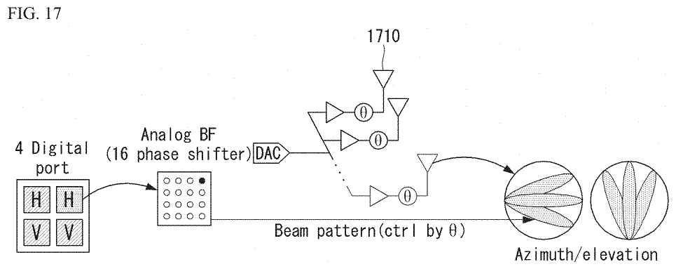

Using the above method, mobile communication performs beamforming, and an example of using an antenna, a phase shifter, and an AMP accordingly is shown in FIG. 17. That is, FIG. 17 shows an example of a general structure for beam generation. FIG. 17 supports 4 digital ports to perform digital beamforming, and each digital port is connected to 16 antenna elements (Ant_el) to enable analog beamforming. In this case, a phase shifter for analog beamforming is supported for each antenna. Since the 16 antenna configurations are composed of a 2D planer array, both azimuth and elevation directions are controllable. At this time, modulation/demodulation for high-frequency band transition exists between the antenna and the DAC, and it is advantageous to place the phase shifter on the antenna side and have a control function from a structural point of view.

Considering the case where the path loss is very severe, such as Thz, the beam gain should be maximally obtained (under limited use power). To this end, a large number of antennas must be used, and at this time, a function must be provided to control the generated beam in a desired direction. The antenna shape of the expected Thz band uses hundreds to thousands of Ant_els, and the interval is expected to be about ½λ to obtain the beam gain. However, it is necessary to have a phase adjuster for each Ant_el for beam control, and a design having hundreds to thousands of phase adjusters in an integrated state requires high implementation difficulty and entails many implementation difficulties such as power consumption and control method.

Therefore, the present disclosure provides a method for generating an entire THz beam using an antenna capable of reconfiguring radiation patterns of one ant_el. As for a method capable of reconfiguring the radiation patterns, as shown in FIG. 18, there is also a method already in use. FIG. 18 is an example of a conventional reconfigurable Ant_el, and FIG. 18 shows an example of generating an antenna element radiation pattern by selectively using a plurality of points. As shown in FIG. 18, a pattern is designed so that beams can be radiated in each of four directions within Ant_el, and diode switches (S1 to S4) that can select it are installed to control the direction of Ant_el radiation. That is, for example, when only the S2 switch is ‘on’ as shown in FIG. 18b, Ant_el emits a beam in the direction of 90 degrees. FIG. 18a shows an example of a circuit diagram of the antenna 1710 in FIG. 17.

As discussed above, communication using the Thz band requires maximization of beam gain due to severe path loss. To this end, there is a technical difficulty in integrating a large number of antennas into a small space. In particular, unlike the sub-6 GHz band or mmWave, which can consider a phase shifter for each antenna element, THz has difficulties in implementation due to the technical requirement of using many antennas in a small space. That is, it may be difficult to use the phase shifter for each antenna due to high integration and high power consumption. For this reason, antenna technology capable of adjusting the phase of a signal without a phase shifter has been developed, but the adjustable phase shift is very limited.

Accordingly, the present disclosure provides a method for generating a beam in the Thz band and controlling the beam in this situation.

In addition, in the present disclosure, beam generation is performed by coarse beam generation, fine beam generation, and utilization between beams, and a control method and structure for this are provided.

More specifically, the method proposed in the present disclosure relates to generating a beam using an antenna element whose phase, direction, or gain is adjustable.

The characteristics of pattern reconfigurable antenna elements developed so far are very limited in their control range and adjustable resolution, so beam control and generation are limited during array formation.

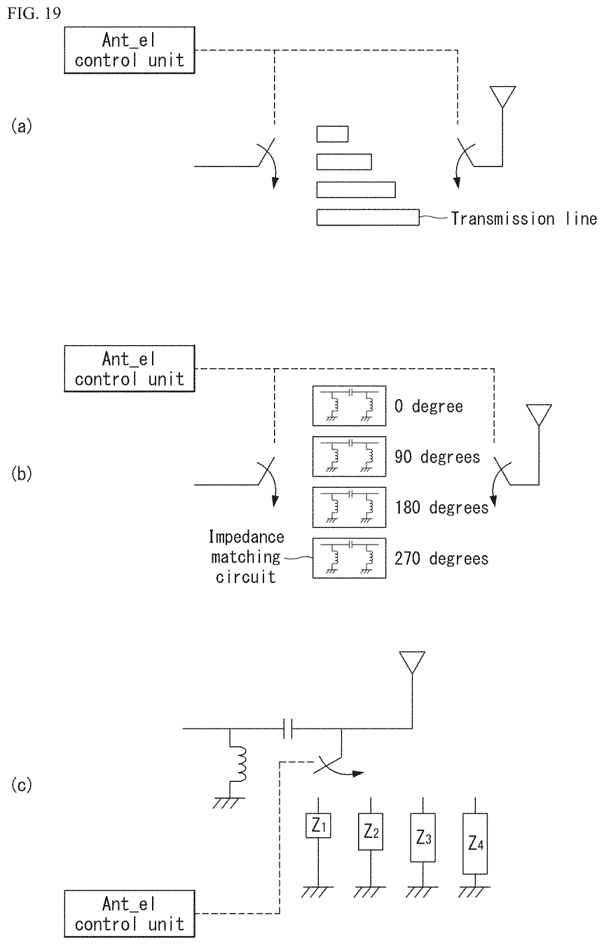

It may be advantageous to be able to adjust the phase characteristics of a reconfigurable antenna in terms of beam generation. Therefore, it can be configured to control Ant_el in the following methods. Method 1, Method 2, and Method 3 below correspond to FIGS. 19a, 19b, and 19c, respectively. That is, FIG. 19 is a diagram showing an example of a method for controlling an antenna element proposed in the present disclosure.

(Method 1)

Method 1 is a method of configuring the length of the line connected to the antenna differently (ex 1λ, 1.25λ, 1.5λ, 1.75λ), and then switching and using them.

(Method 2)

Method 2 is a method of configuring a plurality of impedance matching circuits having different reactances and then switching and using them.

(Method 3)

Method 3 is a method of arranging a plurality of elements so that the reactance in the impedance matching circuit can be adjusted, and then switching and using them.

In addition to the above method, it is also possible to change the phase value through changing the feeding position of the antenna element. Here, the feeding position change means a change of a point at which a signal is applied to an antenna element.

In the case of selecting Reactance among the above methods, the position of the element can be arbitrarily selected. However, the more configurable options (ex: phase, gain, radiation pattern) of the reconfigurable antenna are considered, the more the hardware size and manufacturing difficulty increase, making it difficult to secure sufficient resolution. This becomes a factor that makes it difficult to implement beamforming required in THz, and additional control is required.

Next, a method of generating a beam in the THz band proposed in the present disclosure will be described.

That is, in the following, in order to generate a beam in the THz band using the pattern reconfigurable antenna element, a beam may be generated using at least one of the following three rules.

[Rule 1]

Rule 1 is to group pattern reconfigurable Ante_els (hereinafter, referred to as Ant_Gr) and perform beamforming within the Ant_Gr.

[Rule 2]

Rule 2 is to precisely adjust the beam through phase adjustment between Ant_Gr.

[Rule 3]

Rule 3 relates to utilization (spatial diversity, spatial multiplexing, selective reception, etc.) between beams generated by Rules 1 and 2.

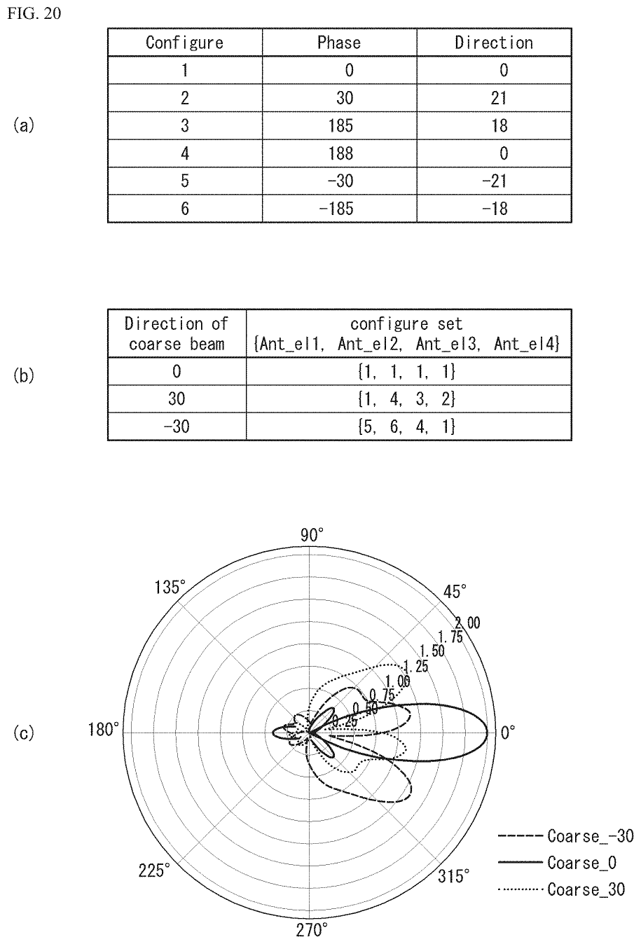

The beam generated by the above Rule 1 is directed to only a part of the entire area. That is, since the resolution of factors (phase, size, direction) controllable only by pattern reconfigurable Ant_el unit control is small, it is insufficient to generate a detailed beam. Therefore, Rule 1 performs only coarse beam generation. FIG. 20c shows an example of a coarse beam generated by Rule 1. FIG. 20 shows an example of beam generation by an antenna group proposed in the present disclosure. Here, Ant_Gr is composed of four Ant_els (Ant_el1 to Ant_el4) in a row at intervals of 0.5λ, and is expressed as (Ant_el1, Ant_el2, Ant_el3, Ant_el4). FIG. 20a shows a phase shift and radial direction change (only the azimuth direction) of a signal controllable by one Ant_el. When the direction of the coarse beam that can be generated by Ant_Gr is set to 0, 30, or −30 degrees, the configuration values of Ant_el are as shown in FIG. 20b. For example, if the coarse beam is to be controlled at 30 degrees, the Configure Set of {Ant_el 1, Ant_el 2, Ant_el 3, Ant_el 4} is configured as {1,4,3,2}. FIG. 20c shows the coarse beam pattern of Ant_Gr generated in this way. The controllable phase, beam direction, and gain of the reconfigurable Ant_el may vary slightly depending on the method for manufacturing the antenna, and the shape and gain, etc. of the coarse beam may vary accordingly.

In addition, in FIGS. 20a and 20b, the phase/direction for the antenna element can be determined more accurately by using an AI algorithm such as machine learning described above in a method for determining the phase/direction of the antenna element.

Also, unlike general methods, the method proposed in the present disclosure first performs beam adjustment for an antenna element and then performs beam adjustment for an antenna group.

The reason for this order is to overcome limitations that may occur in implementation, in the THz band, when performing beam adjustment for an antenna element after beam adjustment for an antenna group, the beam cannot be generated properly. Therefore, a fine beam is generated at the analog end by performing beam adjustment in the order of the antenna element and the antenna group.

Next, a structure for supporting Rule 1 and Rule 2 described in FIGS. 20a and 20b will be described.

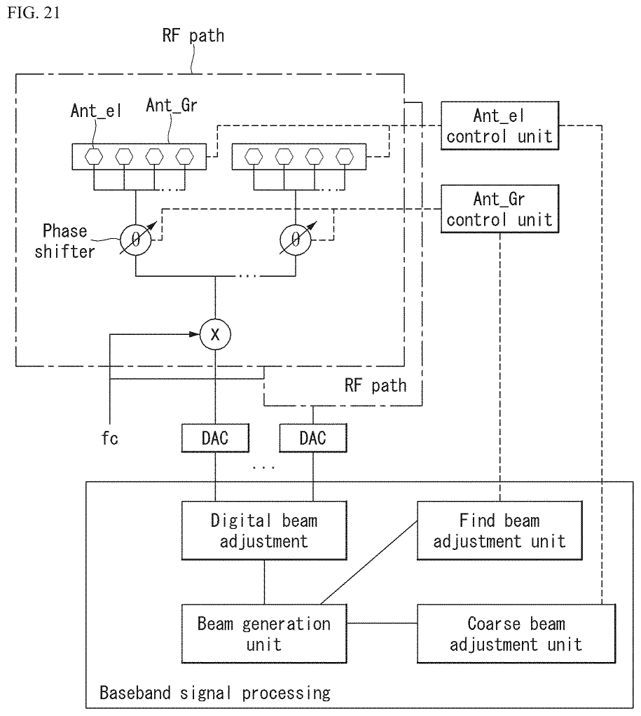

That is, FIG. 21 shows an example of a structure for THz beam generation proposed in the present disclosure.

Specifically, FIG. 21 is an example of a structure for supporting Rule 1 and Rule 2.

Referring to FIG. 21, the ‘beam generation unit’ of the baseband is connected to the ‘digital beam adjustment’, the ‘coarse beam adjustment unit’ and the ‘fine beam adjustment unit’ to perform overall control for beam generation. The ‘coarse beam adjustment unit’ is connected to the ‘Ant_el control unit’ to control Ant_el within Ant_Gr. At this time, the adjustment of Ant_el by the Ant_el control unit is determined by the coarse beam adjustment unit of the baseband, as shown in FIG. 21. The Ant_el control unit can be equally applied to all Ant Gr depending on the purpose of use, and can be applied separately or independently. The ‘fine beam adjustment unit’ to support Rule 2 is connected to the ‘Ant_Gr control unit’ to perform control between Ant_Gr to finely adjust the beams of all antennas included in an arbitrary RF path. ‘Digital beam adjustment’ to support Rule 3 performs MIMO (spatial diversity or spatial multiplexing or selective transmission/reception or additional beam gain, etc.) operation between multiple RF paths in the digital domain, which is each stage before the DAC (or ADC in case of reception).

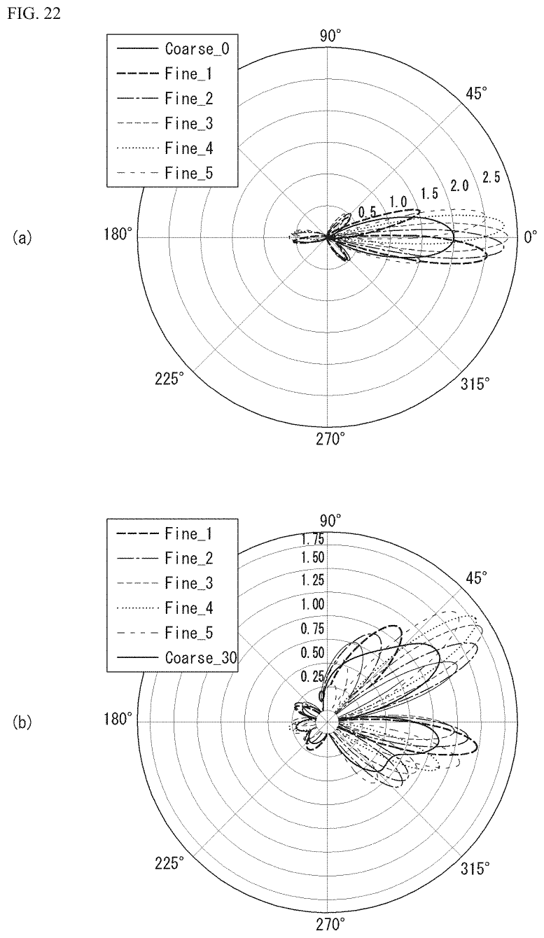

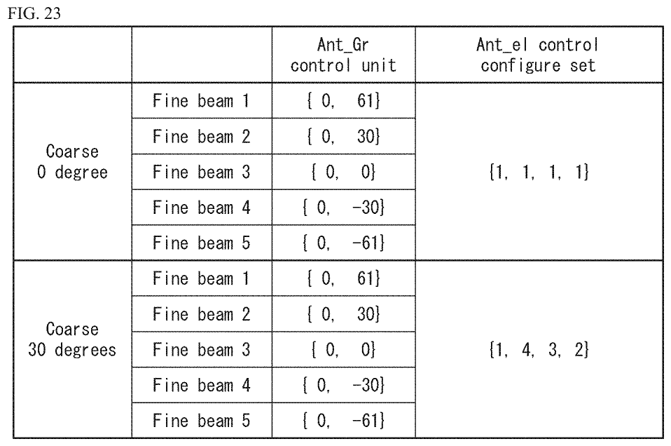

FIGS. 22 and 23 show examples of beam shapes generated by FIGS. 20 and 21. FIG. 22 is a beam shape in the case where two Ant_Gr are assumed and four Ant_els are present in one Ant_Gr. FIG. 23 shows values of ‘Ant_Gr control unit’ and ‘Ant_el control unit’ for generating the beams of FIGS. 22a and 22b.

Referring to FIG. 23, in order to generate a fine beam (fine beam 1) with a beam direction of 5 degrees in FIG. 22, the configuration of the Ant_el control unit is configured as {1,1,1,1} to first generate a coarse 0 degree. As described above, the configuration of the Ant_el control unit is equally applied to the two Ant Gr and generates a coarse 0-degree beam. After that, fine tuning is performed by adjusting the Ant_Gr control unit with a coarse 0-degree beam. That is, the example of FIG. 23 shows an example in which a fine beam 1 is generated when a coarse 0-degree beam is configured and then the phase values of the phase shifters of each Ant_Gr are configured as 0 degrees and 61 degrees through the Ant_Gr control unit, respectively.

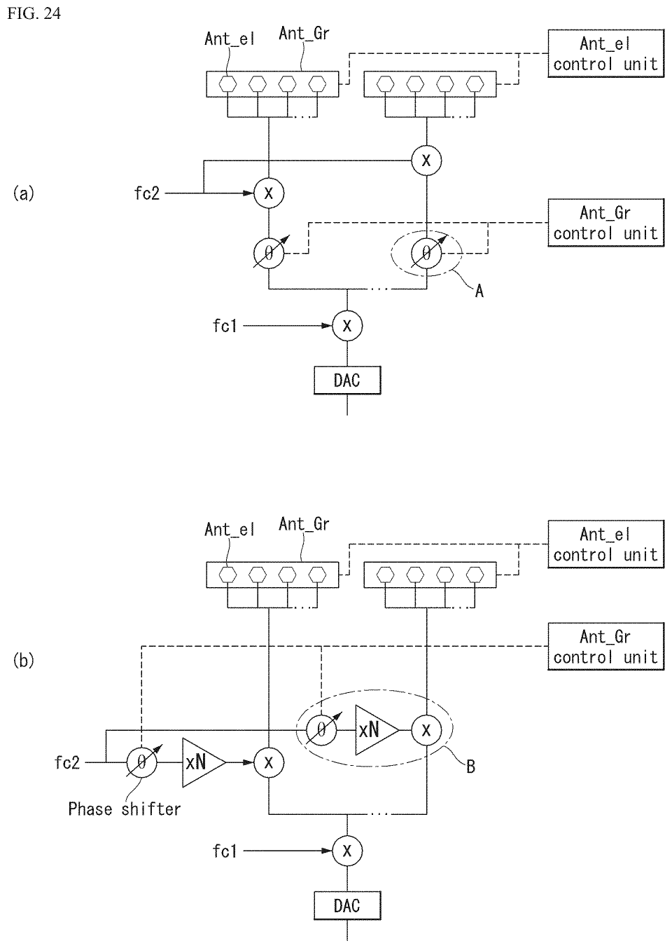

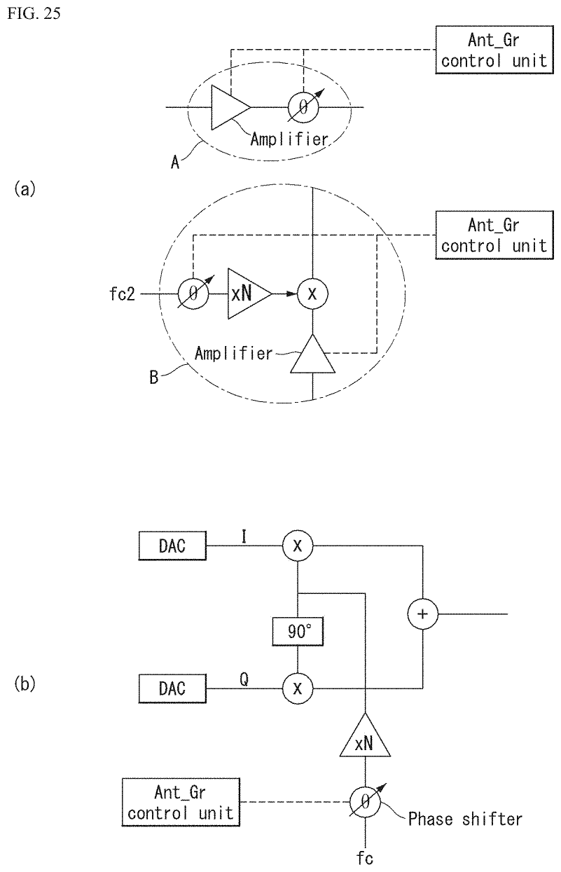

Here, the THz band design is also greatly influenced by the manufacturing process of each component. In the case of a phase shifter, it is not easy to design to satisfy the THz band. Accordingly, the RF path block of FIG. 21 may be modified as shown in FIGS. 24 and 25.

That is, FIGS. 24 and 25 show examples of structures for THz beam generation proposed in the present disclosure.

FIGS. 24a and 24b show an example of the case where the modulation/demodulation process uses the intermediate frequency. FIG. 24a shows that the phase shifter exists in the intermediate frequency band, and FIG. 24b shows that the phase shifter is placed on the THz signal generator side of modulation/demodulation.

If the intermediate frequency is not used, the modulation/demodulation process by fc1 can be omitted. The fc, fc1, and fc2 applied to the RF path can be applied from different signal sources. In FIGS. 21, 24, and 25, various filters and AMPs not related to the beam generating function are not separately shown in the drawings. And, in FIGS. 21, 24, and 25, in the case of a reception operation, the DAC may be expressed as an ADC.

Also, depending on the modulation/demodulation scheme, FIGS. 21, 24, and 25 can be expanded and applied to IQ modulation/demodulation. When fc1 is omitted due to direct conversion in FIG. 24b, IQ modulation and demodulation for the operation of B is as shown in FIG. 25b.

A tapering method for adjusting the side lobe or beam width of the generated beam may be considered, and in this case, an amplifier capable of adjusting the size may be included in addition to the function of the phase shifter. FIG. 25a shows an extension of the amplifier used in this case. A of FIG. 25a is a structure in which an amplifier is combined with the phase shifter of FIG. 24a so that not only the phase but also the gain can be adjusted. In FIG. 25a, B is a structure that obtains the effect of lowering the level of difficulty by placing the amplifier for adjustment of beam width or side lobe in front of the mixer and implementing it in a low band.

If there is only one Ant_Gr in an arbitrary RF path, the phase shifter can be omitted, and at this time, the corresponding function is performed in the ‘Digital beam adjustment’ unit.

In addition, the present disclosure may include a case of using a controllable phase shifter with a low bit (e.g. 1 or 2 bit) for each Ant_el in order to solve the difficulty of implementation instead of a reconfigurable antenna element, which is a basic condition of the method proposed in the present disclosure. At this time, the low bit phase shifter located for each Ant_el is adjusted through the ‘Ant_el control unit’, and the basic principle of generating the coarse beam is the same.

The beam generator in the THz band configured by the method described above can generate various beams for the following purposes.

### (Embodiment 1): Adjustment of the Number of Beams

### Embodiment 1-1) ‘Maximum Beam Gain’ Method: All Antennas are Configured as One Direction Directing Point

As described above, it can be applied to analog beam generation by Rule 1 and Rule 2 and digital beam synthesis using Rule 3.
Rule 1: Configure the Ant_el adjustment configure set to be the same as all Ant_Grs
Rule 2 adjusts between Ane_Gr (FIGS. 22 and 23)
Rule 3 adjusts between paths (co-phase)

Embodiment 1-2) ‘Multi-beam’ transmission and reception (ex: when transmitting and receiving CoMP of a UE): configurating beam direction for each RF path
Rule 1: Configure the Ant_el adjustment configure set to be the same as Ant_Grs within the RF path (however, it may be different between RF paths)
Rule 2: Adjustment between Ane_Grs is carried out for each RF path (determination of the fine beam for each RF path)
Rule 3: Separate signal processing for each RF path (MIMO operation)

Here, (i) in order to additionally obtain a beam gain, Rule 2 may be applied by grouping RF paths in which the positions of Ane_Gr are contiguous.

At this time, in the operation of Rule 3, the grouped RF path performs (co-phase) adjustment between paths, and separate signal processing (MIMO operation) between RF path groups.

And, (ii) in order to maximize beam transmission and reception in multiple directions, each Ant_Gr in Rule 1 can independently apply the Ant_el adjustment configure set.

At this time, the adjustment between Ane_Gr of Rule 2 controls each other's signals to be co-phased.

### (Embodiment 2): Transmission and Reception of ‘Wide-Range Beam’ (Ex: When Considering the Mobility of UE)

Rule 1: Configure the Ant_el adjustment configure set to be the same as Ant_Gr in the RF path (however, it may be different between RF paths).
Rule 2: When adjusting between Ane_Grs, configure the amplifier for tapering to be different for each value (e.g. some amplifiers off)
Rule 3: Separate signal processing for each RF path (MIMO operation)

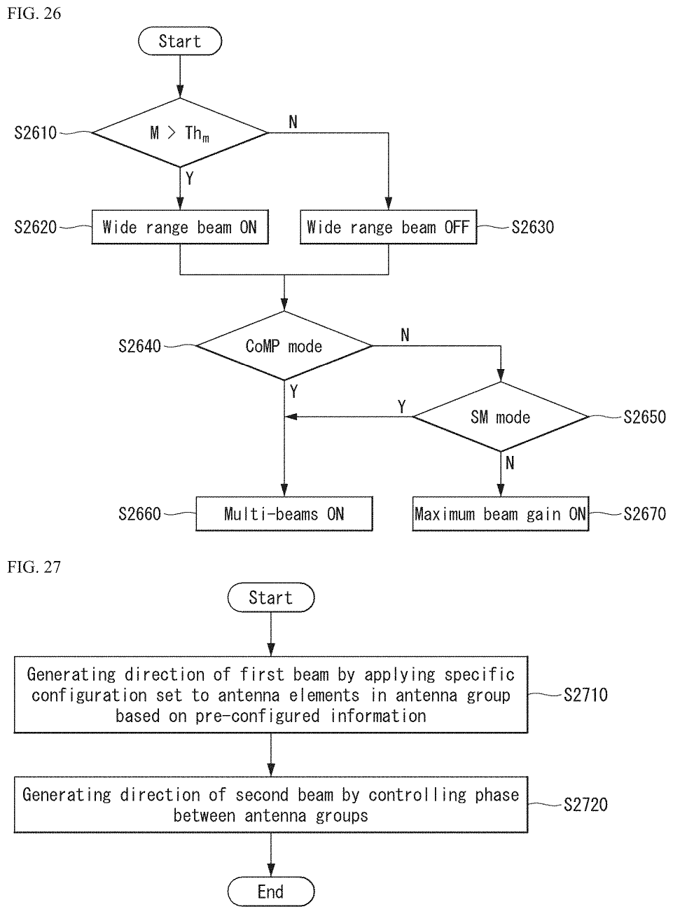

Hereinafter, referring to FIG. 26, a method for generating a beam proposed in the present disclosure will be described. That is, FIG. 26 is a flowchart illustrating an example of a beam generating method proposed in the present disclosure.

A signal transmission/reception apparatus (a UE or a base station) must generate a suitable beam based on the MIMO operation mode or the situation of the UE. For convenience of description, it will be described by assuming a receiving operation of the UE. In FIG. 26, M represents motion of the UE and means motion (or rotation). Thm is a boundary value that determines whether a ‘wide-range beam’ is generated by the motion of the UE. ‘CoMP mode’ is a mode when signals are received from multiple base stations (or TRP: Tx/Rx point). A special multiplexing (SM) mode represents a case where a UE receives two or more streams. The method of FIG. 26 proceeds in the ‘beam generation unit’ of FIG. 21. Table 3 shows an example of the role of each control unit when trying to generate the beam determined by FIG. 26. Here, it is assumed that the UE has a structure with two RF paths (RF1 and RF2), and a structure in which two Ant_Gr (Ant_Gr1 and Ant_Gr2) exist in each RF path, and each Ant_Gr has a plurality of Ant_el.

A more detailed description of FIG. 26 is as follows.

The UE compares a value related to the motion of the UE with a threshold value (S2610). As a result of the comparison, when the value related to the motion of the UE is large, the UE turns on a wide range beam (S2620). As a result of the comparison, when the threshold is large, the UE turns off the wide range beam (S2630).

After that, the UE checks whether it is in CoMP mode (S2640). As a result of the check, in case of CoMP mode, the UE turns on multi-beams (S2660). As a result of the check, when it is not a CoMP mode but SM mode (S2650), the UE turns on multi-beams (S2600). As a result of the check, when if it is neither the CoMP mode nor the SM mode (S2650), the UE turns on the maximum beam gain (S2670).

Table 3 below is a table briefly summarizing the roles of each control unit in FIG. 21.

TABLE 3

| Type of | | | |
|---|---|---|---|
| generated | Coarse beam adjustment | Fine beam | Digital beam |
| beam | unit | adjustment unit | adjustment unit |
| Wide range | Configure configure set | Ant_Gr1 gain off of | MIMO-based signal |
| ON, Multi- | of RF1_Ant_Gr1 and | RF1(Tapering | processing |
| Beam ON | RF1_Ant_Gr2 to be the | technique available), | multi stream: |
| | same. | Ant_Gr1 gain off of | SM signal |
| | Configure configure set | RF2d(Tapering | processing |
| | of RF2_Ant_Gr1 and | technique available | single stream: |
| | RF2_Ant_Gr2 to be the | | combining |
| | same, | | |
| | Coarse beam1 ≠ Coarse | | |
| | beam2 | | |
| Wide range | Configure configure set of | Ant_Gr1 gain off of | Combining-based |
| ON, | RF1_Ant_Gr1, | RF1(Tapering | signal processing |
| Maximum | RF1_Ant_Gr2, | technique available), | |
| Beam Gain | RF2_Ant_Gr1 and | Ant_Gr1 gain off of | |
| ON | RF2_Ant_Gr2 to be the | RF2d(Tapering | |
| | same, | technique available | |
| | Coarse beam1 = Coarse | | |
| | beam2 | | |
| Wide range | Configure configure set | Configure fine beaml | MIMO-based signal |
| OFF, Multi- | of RF1_Ant Gr1 and | as Ant Gr1 and | processing |
| beam ON | RF1_Ant_Gr2 to be the | Ant Gr1 of RF1 | multi stream: SM |
| | same. | Configure fine beam2 | signal processing |
| | Configure configure set | as Ant Gr1 and | single stream: |
| | of RF2_Ant Gr1 and | Ant Gr2 of RF2 | combining |
| | RF2_Ant Gr2 to be the | fine beam1 ≠ fine | |
| | same, | beam2 | |
| | Coarse beam1 ≠ Coarse | | |
| | beam2 | | |
| Wide range | Configure Configure set of | Configure fine beam1 | Combining-based |
| OFF, | RF1_Ant_Gr1, | as Ant_Gr1 and | signal processing |
| Maximum | RF1_Ant_Gr2, | Ant_Gr1 of RF1 | |
| beam gain | RF2_Ant_Gr1 and | Configure fine beam2 | |
| ON | RF2_Ant_Gr2 to be the | as Ant_Gr1 and | |
| | same, | Ant_Gr2 of RF2 | |
| | Coarse beam1 = Coarse | fine beam1 = fine | |
| | beam2 | beam2 | |

FIG. 27 is a flowchart illustrating an example of an operation method of a UE for generating a beam of an antenna proposed in the present disclosure.

That is, FIG. 27 shows a method for generating a beam of an antenna in a wireless communication system supporting the THz band.

First, the UE utilizes pre-configured information to generate a direction of the first beam. Specifically, the pre-configured information includes one or more configuration sets composed of configuration values applied to each of the antenna elements in the antenna group to control the direction of the first beam.

An example of the one or more configuration sets will be referred to FIGS. 20 and 23.

Then, the UE generates a direction of the first beam by applying a specific configuration set to antenna elements in the antenna group based on the pre-configured information (S2710).

Then, the UE generates a direction of a second beam by controlling a phase between the antenna groups (S2720).

Here, the first beam may be a coarse beam, and the second beam may be a fine beam.

And, the specific configuration set may be applied to each of the antenna groups.

In addition, antenna elements in the antenna group may be controlled in various ways. i) For example, the antenna elements in the antenna group may be controlled by configuring lengths of transmission lines connected to an antenna differently. ii) As another example, the antenna elements in the antenna group may be controlled by impedance matching circuits having different reactances or adjustment of a reactance in an impedance matching circuit. iii) As another example, the antenna elements in the antenna group may be controlled by changing a feeding position. The above examples [i) to iii)] are not necessarily individually applied, and the antenna elements in the antenna group may be controlled based on a combination of two or more.

Here, the configuration sets may be used to determine a phase and a direction for each of the antenna elements in the antenna group.

The configuration sets may be determined based on the direction of the first beam.

The phase between the antenna groups may be controlled so that signals between each antenna group are co-phased.

Another operation method of a UE for generating a beam of an antenna proposed in the present disclosure will be described.

After steps S2710 to S2730 of FIG. 27, the UE receives control information related to at least one of a mode of the UE or a motion of the UE from a base station.

The UE compares a value related to the motion of the UE with a threshold value.

As a result of the comparison, when the value related to the motion of the UE is greater than the threshold value, the UE turns on the wide-range beam.

As a result of the comparison, when the value related to the motion of the UE is smaller than the threshold value, the UE turns off the wide-range beam.

Next, the UE checks whether it is in CoMP mode.

As a result of the check, in case of the CoMP mode, the UE turns on multi-beams.

As a result of the check, in case of the SM mode, the UE turns on the maximum beam gain.

Apparatus Used in Wireless Communication System

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

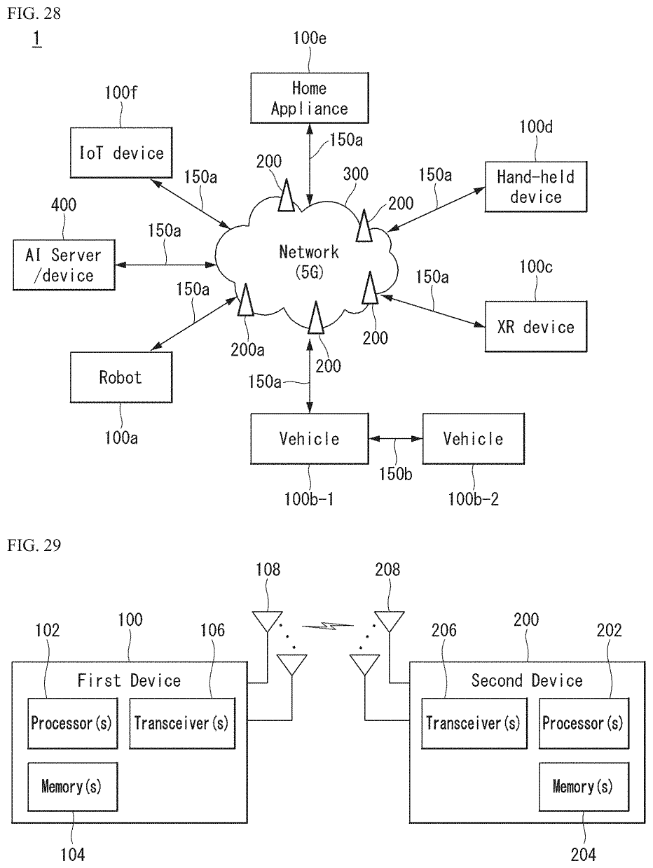

FIG. 28 illustrates a communication system applied to the present disclosure.

Referring to FIG. 28, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connection 150a. 150b may be performed between the wireless devices 100a to 100f/base station 200-base station 200/wireless devices 100a to 100f. Here, the wireless communication/connection may be made through various wireless access technologies (e.g. 5G NR) such as uplink/downlink communication 150a and sidelink communication 150b (or D2D communication). Through the wireless communication/connection 150a and 150b, the wireless device and the base station/wireless device may transmit/receive wireless signals from each other. For example, the wireless communication/connection 150a and 150b may transmit/receive signals through various physical channels based on all/partial processes of FIG. 1. To this end, based on various proposals of the present disclosure, at least some of various configuration information configuration processes for transmitting/receiving radio signals, various signal processing processes (e.g. channel encoding/decoding, modulation/demodulation, resource mapping/demapping, etc.), and resource allocation processes may be performed.

FIG. 29 illustrates wireless devices applicable to the present disclosure.

Referring to FIG. 29, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 28.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the functions, procedures and/or methods explained/proposed above in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the functions, procedures and/or methods explained/proposed above in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the functions, procedures and/or methods explained/proposed above in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the functions, procedures and/or methods explained/proposed above in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the functions, procedures, proposals and/or methods disclosed in this document. The one or more processors 102 and 202 may generate messages, control information, data, or information according to the functions, procedures, proposals and/or methods disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals and/or methods disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the functions, procedures, proposals and/or methods disclosed in this document may be included in the one or more processors 102 and 202 or stored in the one or more memories 104 and 204 so as to be driven by the one or more processors 102 and 202. The functions, procedures, proposals and/or methods disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

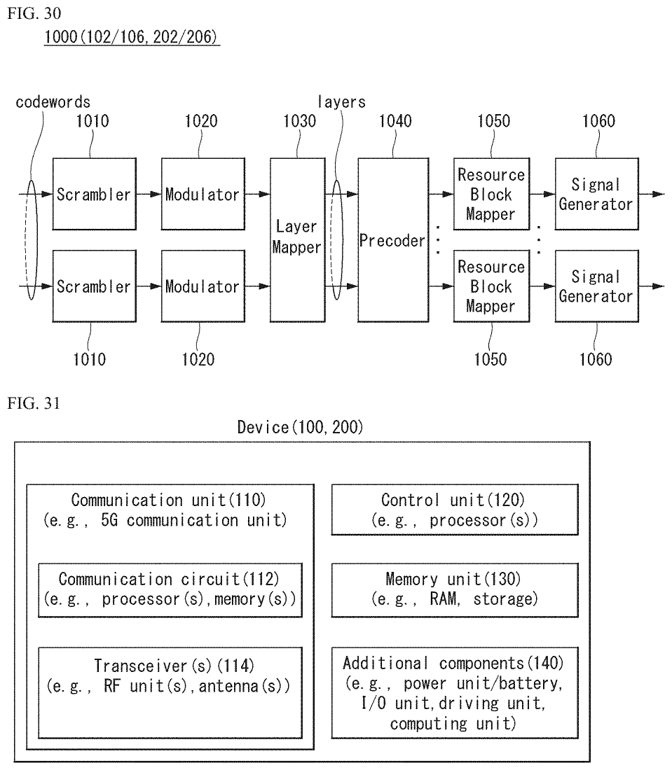

FIG. 30 illustrates a signal process circuit for a transmission signal.

Referring to FIG. 30, a signal processing circuit 1000 may include scramblers 1010, modulators 1020, a layer mapper 1030, a precoder 1040, resource mappers 1050, and signal generators 1060. An operation/function of FIG. 30 may be performed, without being limited to, the processors 102 and 202 and/or the transceivers 106 and 206 of FIG. 29. Hardware elements of FIG. 30 may be implemented by the processors 102 and 202 and/or the transceivers 106 and 206 of FIG. 29. For example, blocks 1010 to 1060 may be implemented by the processors 102 and 202 of FIG. 29. Alternatively, the blocks 1010 to 1050 may be implemented by the processors 102 and 202 of FIG. 29 and the block 1060 may be implemented by the transceivers 106 and 206 of FIG. 29.

Codewords may be converted into radio signals via the signal processing circuit 1000 of FIG. 30. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 30. For example, the wireless devices (e.g., 100 and 200 of FIG. 29) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

FIG. 31 illustrates another example of a wireless device applied to the present disclosure. The wireless device may be implemented in various forms according to a use-case/service.

Referring to FIG. 31, wireless devices 100 and 200 may correspond to the wireless devices 100 and 200 of FIG. 29 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 29. For example, the transceiver(s) 114 may include the one or more transceivers 106 and 206 and/or the one or more antennas 108 and 208 of FIG. 29. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 28), the vehicles (100b-1 and 100b-2 of FIG. 28), the XR device (100c of FIG. 28), the hand-held device (100d of FIG. 28), the home appliance (100e of FIG. 28), the IoT device (100f of FIG. 28), a digital broadcast terminal, a hologram device, a public safety device, an MTC device, a medicine device, a fintech device (or a finance device), a security device, a climate/environment device, the AI server/device (400 of FIG. 28), the BSs (200 of FIG. 28), a network node, etc. The wireless device may be used in a mobile or fixed place according to a use-example/service.

In FIG. 31, the entirety of the various elements, components, units/portions, and/or modules in the wireless devices 100 and 200 may be connected to each other through a wired interface or at least a part thereof may be wirelessly connected through the communication unit 110. For example, in each of the wireless devices 10) and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 31 will be described in detail with reference to the drawings.

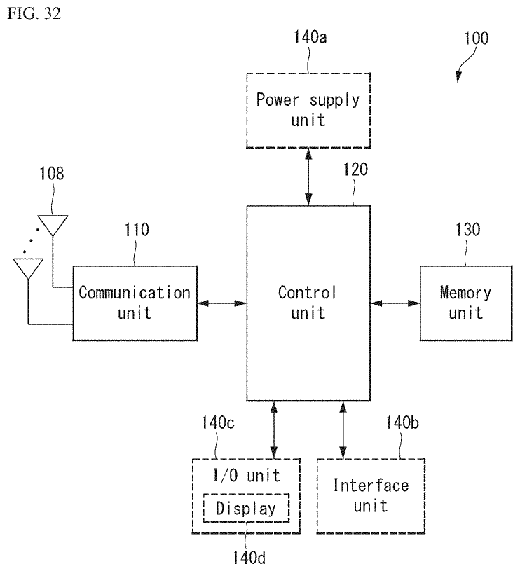

FIG. 32 illustrates a hand-held device applied to the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 32, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 31, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio V/O port and a video V/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

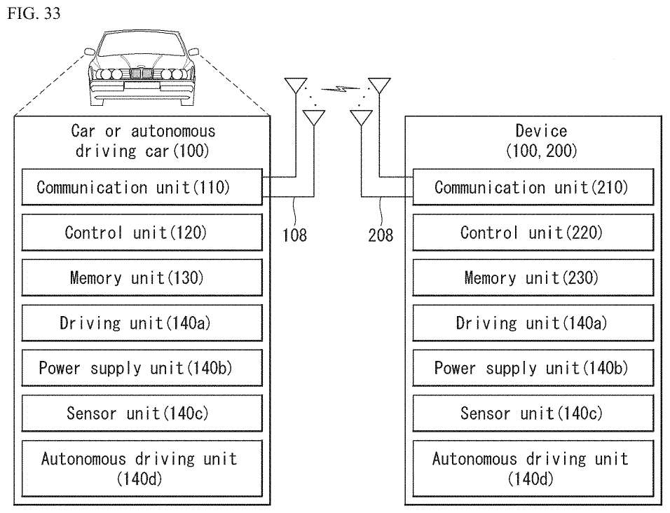

FIG. 33 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 33, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 31, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

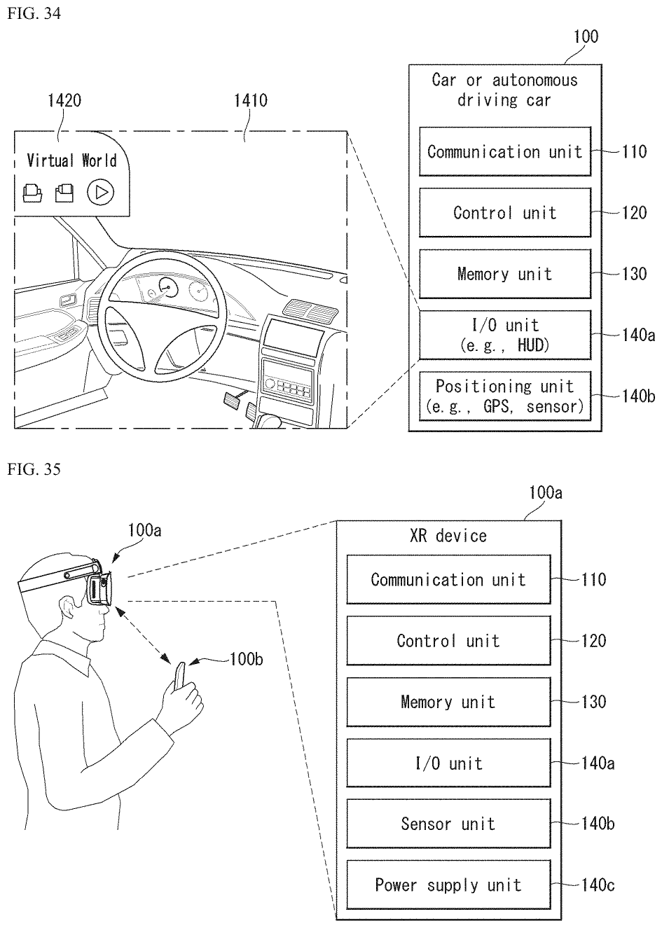

FIG. 34 illustrates a vehicle applied to the present disclosure. The vehicle may be implemented as a transport means, an aerial vehicle, a ship, etc.

Referring to FIG. 34, a vehicle 100 may include a communication unit 110, a control unit 120, a memory unit 130, an V/O unit 140a, and a positioning unit 140b. Herein, the blocks 110 to 130/140a and 140b correspond to blocks 110 to 130/140 of FIG. 31.

The communication unit 110 may transmit and receive signals (e.g., data and control signals) to and from external devices such as other vehicles or BSs. The control unit 120 may perform various operations by controlling constituent elements of the vehicle 100. The memory unit 130 may store data/parameters/programs/code/commands for supporting various functions of the vehicle 100. The I/O unit 140a may output an AR/VR object based on information within the memory unit 130. The I/O unit 140a may include an HUD. The positioning unit 140b may acquire information about the position of the vehicle 100. The position information may include information about an absolute position of the vehicle 100, information about the position of the vehicle 100 within a traveling lane, acceleration information, and information about the position of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain the vehicle position information through the GPS and various sensors and store the obtained information in the memory unit 130. The control unit 120 may generate a virtual object based on the map information, traffic information, and vehicle position information and the I/O unit 140a may display the generated virtual object in a window in the vehicle (1410 and 1420). The control unit 120 may determine whether the vehicle 100 normally drives within a traveling lane, based on the vehicle position information. If the vehicle 100 abnormally exits from the traveling lane, the control unit 120 may display a warning on the window in the vehicle through the I/O unit 140a. In addition, the control unit 120 may broadcast a warning message regarding driving abnormity to neighboring vehicles through the communication unit 110. According to situation, the control unit 120 may transmit the vehicle position information and the information about driving/vehicle abnormality to related organizations.

FIG. 35 illustrates an XR device applied to the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 35, an XR device 100a may include a communication unit 110, a control unit 120, a memory unit 130, an V/O unit 140a, a sensor unit 140b, and a power supply unit 140c. Herein, the blocks 110 to 130/140a to 140c correspond to the blocks 110 to 130/140 of FIG. 31, respectively.

The communication unit 110 may transmit and receive signals (e.g., media data and control signals) to and from external devices such as other wireless devices, hand-held devices, or media servers. The media data may include video, images, and sound. The control unit 120 may perform various operations by controlling constituent elements of the XR device 100a. For example, the control unit 120 may be configured to control and/or perform procedures such as video/image acquisition, (video/image) encoding, and metadata generation and processing. The memory unit 130 may store data/parameters/programs/code/commands needed to drive the XR device 100a/generate XR object. The I/O unit 140a may obtain control information and data from the exterior and output the generated XR object. The I/O unit 140a may include a camera, a microphone, a user input unit, a display unit, a speaker, and/or a haptic module. The sensor unit 140b may obtain an XR device state, surrounding environment information, user information, etc. The sensor unit 140b may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit 140c may supply power to the XR device 100a and include a wired/wireless charging circuit, a battery, etc.

For example, the memory unit 130 of the XR device 100a may include information (e.g., data) needed to generate the XR object (e.g., an AR/VR/MR object). The I/O unit 140a may receive a command for manipulating the XR device 100a from a user and the control unit 120 may drive the XR device 100a according to a driving command of a user. For example, when a user desires to watch a film or news through the XR device 100a, the control unit 120 transmits content request information to another device (e.g., a hand-held device 100b) or a media server through the communication unit 130. The communication unit 130 may download/stream content such as films or news from another device (e.g., the hand-held device 100b) or the media server to the memory unit 130. The control unit 120 may control and/or perform procedures such as video/image acquisition, (video/image) encoding, and metadata generation/processing with respect to the content and generate/output the XR object based on information about a surrounding space or a real object obtained through the I/O unit 140a/sensor unit 140b.

The XR device 100a may be wirelessly connected to the hand-held device 100b through the communication unit 110 and the operation of the XR device 100a may be controlled by the hand-held device 100b. For example, the hand-held device 100b may operate as a controller of the XR device 100a. To this end, the XR device 100a may obtain information about a 3D position of the hand-held device 100b and generate and output an XR object corresponding to the hand-held device 100b.

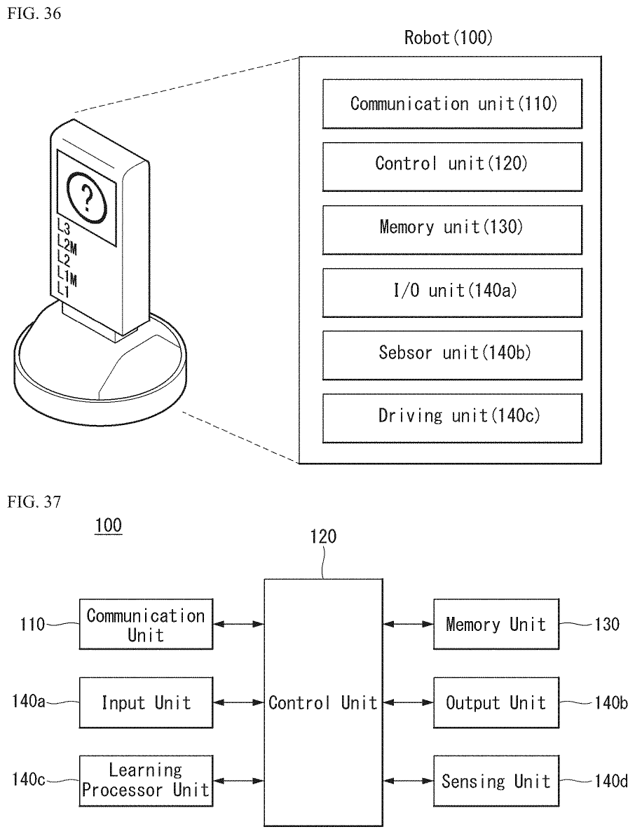

FIG. 36 illustrates a robot applied to the present disclosure. The robot may be categorized into an industrial robot, a medical robot, a household robot, a military robot, etc., according to a used purpose or field.

Referring to FIG. 36, a robot 100 may include a communication unit 110, a control unit 120, a memory unit 130, an I/O unit 140a, a sensor unit 140b, and a driving unit 140c. Herein, the blocks 110 to 130/140a to 140c correspond to the blocks 110 to 130/140 of FIG. 31, respectively.

The communication unit 110 may transmit and receive signals (e.g., driving information and control signals) to and from external devices such as other wireless devices, other robots, or control servers. The control unit 120 may perform various operations by controlling constituent elements of the robot 100. The memory unit 130 may store data/parameters/programs/code/commands for supporting various functions of the robot 100. The I/O unit 140a may obtain information from the exterior of the robot 100 and output information to the exterior of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may cause the robot 100 to travel on the road or to fly. The driving unit 140c may include an actuator, a motor, a wheel, a brake, a propeller, etc.

FIG. 37 illustrates an AI device applied to the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 37, an AI device 100 may include a communication unit 110, a control unit 120, a memory unit 130, an I/O unit 140a/140b, a learning processor unit 140c, and a sensor unit 140d. The blocks 110 to 130/140a to 140d correspond to blocks 110 to 130/140 of FIG. 31, respectively.

The communication unit 110 may transmit and receive wired/radio signals (e.g., sensor information, user input, learning models, or control signals) to and from external devices such as other AI devices (e.g., 100x, 200, or 400 of FIG. 28) or an AI server (e.g., 400 of FIG. 28) using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling constituent elements of the AI device 100. For example, the control unit 120 may request, search, receive, or use data of the learning processor unit 140c or the memory unit 130 and control the constituent elements of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 28). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 28). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

Here, wireless communication technology implemented in wireless devices (e.g., 100/200 of FIG. 29) of the present disclosure may include Narrowband Internet of Things for low-power communication in addition to LTE. NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices (e.g. 100/200 of FIG. 29) of the present disclosure may perform communication based on LTE-M technology. In this case, as an example, the LTE-M technology may be an example of the LPWAN and may be called various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M. Additionally or alternatively, the wireless communication technology implemented in the wireless devices (e.g. 100/200 of FIG. 29) of the present disclosure may includes at least one of ZigBee. Bluetooth, and Low Power Wide Area Network (LPWAN) considering the low-power communication, and is not limited to the name described above. As an example, the ZigBee technology may generate personal area networks (PAN) associated with small/low-power digital communication based on various standards including IEEE 802.15.4, and the like, and may be called various names.

In the aforementioned embodiments, the elements and characteristics of the present disclosure have been combined in a specific form. Each of the elements or characteristics may be considered to be optional unless otherwise described explicitly. Each of the elements or characteristics may be implemented in a form to be not combined with other elements or characteristics. Furthermore, some of the elements or the characteristics may be combined to form an embodiment of the present disclosure. The sequence of the operations described in the embodiments of the present disclosure may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present disclosure may be materialized in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure. [Industrial Availability]

Although the present disclosure has been described focusing on examples applying to 3GPP LTE/LTE-A system and 5G system (new RAT system), the present disclosure can also be applied to other various wireless communication systems.

1. A method for generating a beam of an antenna in a wireless communication system supporting a THz band, the method performed by a user equipment (UE) comprising:
generating a direction of a first beam by applying a specific configuration set to antenna elements in an antenna group based on pre-configured information, wherein the pre-configured information includes one or more configuration sets composed of configuration values applied to each of the antenna elements in the antenna group to control the direction of the first beam; and
generating a direction of a second beam by controlling a phase between antenna groups.

2. The method of claim 1, wherein the first beam is a coarse beam, and the second beam is a fine beam.

3. The method of claim 2, wherein the specific configuration set is applied to each of the antenna groups.

4. The method of claim 2, wherein the antenna elements in the antenna group,
i) configuration of lengths of transmission lines connected to an antenna differently
ii) impedance matching circuits having different reactances or adjustment of a reactance in an impedance matching circuit
iii) changing a feeding position of an antenna element
are controlled based on at least one of i) to iii) above.

5. The method of claim 2, wherein the configuration sets are used to determine a phase and a direction for each of the antenna elements in the antenna group.

6. The method of claim 2, wherein the configuration sets are determined based on the direction of the first beam.

7. The method of claim 2, wherein the phase between the antenna groups is controlled so that signals between each antenna group are co-phased.

8. The method of claim 1, further comprising:
receiving control information related to at least one of a mode of the UE and a motion of the UE from a base station;
comparing a value related to the motion of the UE with a threshold based on the control information;
determining the mode of the UE based on the control information; and
determining whether to turn on multi-beams or turn on a maximum beam gain based on the comparison result and the determined mode of the UE.

9. The method of claim 8, wherein the mode of the UE is a coordinated multi-point (CoMP) mode or a spatial multiplexing (SM) mode.

10. The method of claim 9, wherein when the value related to the motion of the UE is greater than the threshold and the mode of the UE is the CoMP mode, the multi-beams are turned on.

11. A user equipment (UE) for generating a beam of an antenna in a wireless communication system supporting a THz band, the first UE comprising:
a transmitter transmitting a radio signal;
a receiver receiving a radio signal;
at least one processor; and
at least one computer memory operably connectable to the at least one processor and storing instructions that perform operations when executed by the at least one processor,
wherein the operations include:
generating a direction of a first beam by applying a specific configuration set to antenna elements in an antenna group based on pre-configured information, wherein the pre-configured information includes one or more configuration sets composed of configuration values applied to each of the antenna elements in the antenna group to control the direction of the first beam; and
generating a direction of a second beam by controlling a phase between antenna groups.

12. The UE of claim 11, wherein the first beam is a coarse beam, and the second beam is a fine beam.

13. The UE of claim 12, wherein the specific configuration set is applied to each of the antenna groups.

14. The UE of claim 12, wherein the antenna elements in the antenna group,
i) configuration of lengths of transmission lines connected to an antenna differently
ii) impedance matching circuits having different reactances or adjustment of a reactance in an impedance matching circuit
iii) changing a feeding position of an antenna element
are controlled based on at least one of i) to iii) above.

15. The UE of claim 12, wherein the configuration sets are used to determine a phase and a direction for each of the antenna elements in the antenna group.

16. The UE of claim 12, wherein the configuration sets are determined based on the direction of the first beam.

17. The UE of claim 12, wherein the phase between the antenna groups is controlled so that signals between each antenna group are co-phased.

18. The UE of claim 11, wherein the operations further include:
receiving control information related to at least one of a mode of the UE and a motion of the UE from a base station;
comparing a value related to the motion of the UE with a threshold based on the control information;
determining the mode of the UE based on the control information; and
determining whether to turn on multi-beams or turn on a maximum beam gain based on the comparison result and the determined mode of the UE.

19. The UE of claim 18, wherein the mode of the UE is a coordinated multi-point (CoMP) mode or a spatial multiplexing (SM) mode.

20. The UE of claim 19, wherein when the value related to the motion of the UE is greater than the threshold and the mode of the UE is the CoMP mode, the multi-beams are turned on.
